(19) United States
(12) Patent Application Publication
(10) Pub. No.: US 2025/0148528 A1
(43) Pub. Date: May 8, 2025

(54) SUSTAINABLE ACTION-DRIVEN DEEP SOCIAL NETWORK; A UNIFIED INFRASTRUCTURE TO IMPLEMENT GOOD CAUSE ACTIVITIES TOWARDS ACHIEVEMENT OF THE COMMON GOALS

(71) Applicant: Shlomit BENOISH, Tel Aviv (IL)

(72) Inventor: Shlomit BENOISH, Tel Aviv (IL)

(21) Appl. No.: 18/832,225

(22) PCT Filed: Jan. 25, 2023
(86) PCT No.: PCT/IB2023/050624

§ 371 Date: Jul. 23, 2024

Related U.S. Application Data
(60) Provisional application No. 63/302,776, filed on Jan. 25, 2022.

(51) Int. Cl. G06Q 30/0601; G06Q 50/00; G06Q 50/22

(52) U.S. Cl. CPC G06Q 30/0641; G06Q 30/0623; G06Q 50/01; G06Q 50/22

(57) ABSTRACT

A social volunteering trade, payment and distributed-storage computerized deep network system, comprising the following entities: social communities; system users using the system for selling or buying products wherein at least part of the proceeds to manage and control said social trade and to match social values of said users and said communities; a system website; a search engine configured to enable said users to seek said products according to said social values; a system network configured to communicate between said entities; a reports module configured to calculate each community and each user's contribution to predefined goals and publish said calculation results; and feedback means configured to back-propagate said events' outcomes.

### CROSS-REFERENCE TO RELATED PATENT APPLICATIONS

This patent application claims priority from and is related to U.S. Provisional patent Application Ser. No. 63/302,776, filed Jan. 25, 2022, this U.S. Provisional Patent Application incorporated by reference in its entirety herein.

### TECHNOLOGY FIELD

The present invention is in the field of deep social networks and more specifically targeted at facilitating voluntary actions and participation in social entrepreneurship.

### BACKGROUND

The 2030 Agenda for Sustainable Development, adopted by all United Nations Member States in 2015, provides a shared blueprint for peace and prosperity for people and the planet, now and into the future. At its heart are the 17 Sustainable Development Goals (SDGs), which are an urgent call for action by all countries—developed and developing—in a global partnership. They recognize that ending poverty and other deprivations must go hand-in-hand with strategies that improve health and education, reduce inequality, and spur economic growth—all while tackling climate change and working to preserve our oceans and forests.

In the last few decades, digital technologies, computerization, and the internet have been playing a major role in shaping the behavior of the individual, the community, the society, and the economy, and imposing new game-changing rules in all realms of life. We witness structural changes relating to social organizations, control mechanisms, information, and social hierarchies. These changes affect the social structure; a new world of habits, norms, experiences, identities, and interpersonal relationships are created on social network sites. One of the indicators that may point to the public complacent approach today, is the frequently increasing average worldwide use of social media (from 90 minutes on average per day in 2012 to 147 minutes on average per day in 2022 as compared to the amount spent volunteering, which remains steady in the U.S. from 2008 to 2017. The data shows that no more than a quarter of the adult population in America chooses to participate in voluntary activity. This limited population spends 128-137 hours a year volunteering (this figure has remained stable over the years). This shows that there is no correlation between the growth of social media use and the volunteering numbers.

One example could be a zoom-in on food saving processes, showing volunteering trends and requirements. Rescuable food figures in America are estimated at 218 billion dollars a year, about 40% of it thrown out of restaurants. It is absurd that fresh food is thrown out while every sixth child suffers from food insecurity. This food could provide an immediate response and reduce hunger and poor nutrition, which are harming a child's successful education and future. Implications on parents struggling to provide food safety may affect their functioning and emotional state. The gap is fraught with additional costs, such as the resources municipalities invest in the waste treatment process, which is an expensive process in two aspects: the economic burden of municipal taxes on citizens and the implication on the environment, the so-called “carbon footprint”, causing global warming, leading to many more issues, which if not soon addressed, will be irreversible.

Insights from an observed food rescue non-profit organization, show that small business owners, such as restaurants that operate a stall in the cooked food market, need to continue selling until the very moment the market closes. Unfortunately, most small business owners do not have the luxury of handling leftover food. Every Friday at 16:00, at the food markets close, volunteers work efficiently to collect and distribute the remaining food to people in need, leaving no food wasted. Each volunteer has a list of addresses for delivery. This being a regular weekly activity, timed at an unattractive hour, due to the short weekend being the only time to be with family, volunteering requires commitment, family backup, and preparation in advance. The freshest quality food collected is valuable and greatly serves the families throughout the week. The volunteering task is meaningful, and the atmosphere of great teamwork is empowering all participants.

The volunteer's attendance, and the activity management is critical to the food-saving process. However, many nonprofit organizations' leaders are struggling to maintain continuous activity, volunteers' long relationship management, and trust building with funding, with the basics practices of project management mostly using an excel sheet. Volunteering is what you choose to do in your free time. We are all busy with heavy to-do-list. It seems that volunteering is not a priority today. But it is not the people. There is a good intention.

Many individual ventures, associations, and nonprofit organizations were established by social leaders, to solve real-life problems that have required an immediate response. Those individuals took upon themselves the responsibility of providing aid and/or chose to act to fill the gaps where governments and authorities could not respond in an immediate manner. The reality today is that the world is facing a crisis and the importance of such activities is crucial for society.

In fundraising within the social media platforms today, there are many cases where people ask for immediate financial aid, some cases are to assist with a circumstance due to a severe health situation or other personal hardship, and some are crowdfunding for an important venture. We find ourselves many times donating as much as we can to support close friends or important initiatives. We are all well aware that the financial situation is tough today and we are all overwhelmed with so many fundraising requests. We think that a better sustainable way of fundraising should be adopted. If instead of a money transfer, we could leverage the value of our unused goods. If we had a way to open a fundraising event to assist a friend in need, or to support a nonprofit organization, just that instead of asking for a bank transfer, we could ask to donate unused goods. A trade where all or a portion of the revenue is allocated for a good-cause venture is a better way to utilize our resources you can sell your unused goods to get back the worth of the goods, a great way for decluttering and saving many for yourself or allocate a portion to support a good cause venture. The Reuse of the goods is environmentally and socially friendly, a great practice that the system rewards you for and encourages you to adopt. The sustainable way of trade is only one of the sustainable marketplace missions, that is designed to be an exposure gateway to the good cause scene, provides a great user experience to learn about the good-doing ventures around the world and in our local community and it eases not only the fundraising for good cause-organizations and events, but also opens up the view and invites the public to learn and monitor the way and fields they act in, expose their achievements and activities and eases the way to choose a favorite good-cause venture and the process of choosing and committing to volunteering task.

While many people around the globe are in need of urgent aid, when atmospheric co2 levels are reaching record highs each year and the effect of climate changes become more and more profound, others are not aware of the power they have, or do not know how to contribute, and feel overwhelmed or struggling to trust entities, causing a low rate of involvement in volunteering and socially productive activities. There is a good-doing gap when public goodwill and good intentions are not always translated into action. Whereas the individual does not understand the effect of a small action that he could take on the global situation, with the slow nature of policy changes, the positive change that has started may take years to cause a big scale impact, to bring an efficient result. With charity organizations struggling to respond to all needs, we believe that there is a need for a dedicated platform to provide a unified infrastructure for better synchronization of all entities' efforts. The platform aims to serve every social entrepreneur, charity, community, non-profit organization, small business and all commercial and academic sectors, municipalities, and governments. The platform puts the social activity at the center of the public life by paying special attention to the individual as a decision maker and helping empower each one of us to better understand and choose why, where when and how to contribute.

The integrative unified infrastructure focuses on management and continues improvement and scale up the good-cause activity everywhere anytime on the globe. Aim to build stronger partnership in local, far, and distributed communities, to unified society efforts to close gaps and act as a whole ecosystem and not just towards one crisis or a goal. the system aim to better leverage the individual good-will towards positive activity, to grow social contribution, empower social leadership, to support the supporters, to spot on and empower the social leaders activity in each venture or organization they act, to better utilize their leadership skills, to grow their mission's achievement by providing them end to end supporting system process management best practices with step by step structure to break big missions into smaller tasks and action items, Identify resources, build partnerships, and engage effectively with community members, promote volunteerism, Integrative solution uses a radial-based approach to support continuous improvement.

The system supports the supporters, helps social leaders to shift from solving most of the problem by themselves, to growing their activity by leading and building an effective and happy community to take on the load. To help them with planning, and with the execution, and supervision on how to break the big mission into action items. What needs to be done first, make sure all requirements are well-defined. The on boarding and training is clear, help them create the communications channels. Help them find resources and build long partnership. How to interact with the community to maintain the volunteers, to shape the best activity practices, to make sure the mission is well-defined, support the mission to operate transparently. Help them shine, make sure they are appealing to the community.

It integrates the social activity in everybody life, rout and balance the load better to better fulfil our skills, fit our values and purposes, open up the observation and map the possible opportunities and activities performance and influence are clearly seen at any given moment to be clearly understand, easier to access, more local, more efficient more respecting your time, availability constraints, Together we can change the equation, to saw the partnership seeds and develop a growing proactive social and eco-friendly rewording experience. The system helps to synchronize all the systems together to leverage the financial profit of each contributor and better understand how the economy society and environment well connected and support each other a in every circle of life. We can build a better society we can boost and speed up the impact, making the change we all wish to see.

### SUMMARY

According to a first aspect of the present invention there is provided a social volunteering trade, payment and distributed-storage computerized deep network system, comprising the following entities: social communities registered to the system; system users using the system for selling or buying products wherein at least part of the proceeds are donated to one or more of said communities; at least one database comprising records pertaining to said social communities, said users and said products and to volunteering events being planned or executed; social payment means configured to provide a buyer with donation options; system software configured to manage and control said social trade and to match social values of said users and said communities; a system website comprising data related to said communities, said users and their social values, said website additionally comprising connection to a search engine configured to enable said users to seek said products according to said social values; a system network configured to communicate between said entities; a reports module configured to calculate each community and each user's contribution to predefined goals and publish said calculation results; and feedback means configured to back-propagate said events' outcomes.

The system website may comprise community entries and user entries.

The system users may comprise at least one of individual users and commercial users.

Each one of said community entries may comprises: information regarding the community's social values and activities; and a community store listing all the products currently being offered by users, wherein at least part of the proceeds were donated to the community; and a link to the community's website.

At least one of said community entries may comprise a wish list of products currently in urgent demand for the community's activities.

At least one of said community entries may comprise a virtual community storage comprising all the products currently being donated free of charge by said system users or by other community members to said community.

Each one of said individual user entries may comprises: information regarding the user's social values; user's favorite communities; personal user information; default proceedings allocation; and a user store comprising images and descriptions of products currently offered by the user, wherein each product image is accompanied by a price and a graphical representation of the proceeds allocation.

Said user entries may additionally comprise a user dashboard configured to display said user's social activities in the system and their calculated contribution to one or more predefined goals. Said user entries may additionally comprise links to said user's contacts in the system.

Each one of said commercial user entries may comprises: information regarding the commercial user's social values committed to by said commercial user; commercial user's favorite communities; default proceeds allocation; and link to said commercial user's online store.

Said commercial user entries may additionally comprise a user dashboard configured to display said user's social activities in the system and their calculated contribution to one or more predefined goals.

Said at least one database pertaining to volunteering events may comprise, for each event, an event scheduler configured to define the event's schedule, based on a learning process conducted on said feedback.

Said social payment means may be designed to communicate between electronic commerce payment means and said system software, to enable distribution of a payment done by a buyer using said electronic payment means, for a product offered by a seller, according to a predefined seller allocation.

Said predefined seller allocation may be modified by at least one of said seller and said buyer.

Said social payment means may represent graphically said allocation.

Said search engine may be configured to search said system database for products, said search filtered by at least one of product category, searcher's social values and searcher's location information.

The system may further comprise product delivery route optimization means.

According to a second aspect of the present invention there is provided a method of registering to the system of claim 1, comprising the steps of: providing the system with personal information of the user, said information selected from the group comprising name, address, user name, password, default pickup locations for offered products, default times of availability in said pickup locations, bank account details and links to social media.

Said personal information may additionally comprise at least one of a list of said user's social values and a list of the user's favorite locations for performing social volunteering activities.

Said social values may be selected by the user from a list displayed by the system. And

The user may select favorite communities from a list displayed by the system.

The displayed communities may be selected by the system according to at least one of said user's social values and said user's favorite locations for performing social volunteering activities.

The method may further comprise defining by said user a default allocation of funds received for said user's sales.

The default allocation may be presented to the user graphically.

According to a third aspect of the present invention there is provided a method of offering a product for sale by a user of the system of claim 1, comprising the steps of: entering said product's description and requested price into a predefined online store of said user in the system, said description comprising at least one of an image and text; displaying by the system said user's predefined default pickup address and proceeds allocation; and optionally modifying at least one of said pickup address and said proceeds allocation.

The method may further comprise the step of requesting and receiving from the system expert help in determining said product's requested price.

The expert help may be provided by human experts qualified by the system.

The expert help may be provided automatically by the system, based on previous transactions. According to a fourth aspect of the present invention there is provided a method of performing a product search using an online search engine provided by the system of claim 1, comprising the steps of: receiving from a user search terms, wherein said search terms comprise said user's social values; searching said systems' databases for matching products; filtering said matched products according to sellers having social values similar to said user's social values; and presenting said matched products to said user.

The search terms may further comprise said user's location; and the filtering may further comprise filtering the matched products according to sellers' locations.

The method of claim 30, further comprising filtering said matched products according to locations of said user or said sellers' contacts in the system, to provide a recommended pick-up route.

The presenting may comprise: presenting said sellers' favorite communities and intended proceeds allocation between them in the system; and enabling the user to drill down to said communities' profiles in the system.

The presenting may comprise displaying said sellers' locations on a map.

A funds allocation and payment graphic tool comprising percentages of a transaction' proceeds defined by a seller to be allocated to various social communities.

According to a fifth aspect of the present invention there is provided a method of using the funds' allocation and payment tool in a transaction, comprising: displaying said tool on a payment window; selecting said tool as payment means by a buyer performing a purchase; selecting by the buyer a payment option; and transferring the payment to said social communities. According to a sixth aspect of the present invention there is provided a method of creating and operating a volunteering event in the system of claim 1, comprising the steps of: defining an event; dividing said event into separate tasks to be performed by various entities, including an event manager and volunteers; finding volunteers for the event tasks; operating the event; and reporting and displaying each participating entity's contribution to the event.

The defining may comprise receiving an event schedule from the system, said schedule based on previously successful events of a similar type, using the system's learning process.

The finding volunteers may comprise at least one of: self-initiated selection of published tasks by users of the system and system-initiated selection of volunteers according to users' proclaimed social values, free times and location.

The method may further comprise calculating the event's contribution to predefined global goals; and reporting and displaying said calculated contribution to said event manager.

The method may further comprise receiving feedback from said participating entities and updating said event schedule accordingly.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a block diagram of the main components of system 100;

FIG. 2 is a block diagram of an exemplary profile of a local community 201 in the system; 202

FIG. 3 is a block diagram of an exemplary profile of an Individual user 301 in the system;

FIG. 4 is a block diagram of an exemplary profile of a commercial user 401 in the system;

FIG. 5 is a block diagram of a number of databases used by the system to perform its various operations;

FIG. 6 a block diagram showing the operational connections between the events database 510 and the various system entities cooperating in the activation of the system;

FIG. 7 is a block diagram of the reports module;

FIG. 8 is a block diagram showing a detailed description of an event entry in the events database;

FIG. 9 is a block diagram showing a detailed description of a single (individual or commercial) user's entry in the users' database;

FIG. 10 is a block diagram showing a detailed description of a single community's entry in the communities' database;

FIG. 11 is a flowchart 1100 showing the process of a new user's registration to the system;

FIG. 12 is a flowchart 1200 showing a registered individual user 301 operations for adding a product to her store;

FIG. 13 is a flowchart 1300 showing a purchase operation by a buyer in the trade mode;

FIG. 14 is a representation of the novel payment method and funds allocation graphic tool;

FIG. 15 is a graphic representation of manipulating the graphic allocation tool;

FIG. 16A is a schematic representation of the payment process according to the present invention;

FIG. 16B is a schematic representation of the payment allocation process according to the present invention;

FIG. 17 is a flowchart 1700 representing an optimal pickup route suggestion by the system;

FIG. 18 is a block diagram showing the various entities involved in the system's volunteering mode and their roles, by using the example of food rescue activity;

FIG. 19A is a flowchart 1901 showing an exemplary food rescue process preparation;

FIG. 19B is a flowchart 1902 showing an exemplary food rescue process operation;

FIG. 20A shows a graphic representation of the requirements management map for planning a food rescue event, identifying locations and food quantities demand;

FIG. 20B shows a graphic representation of the resources management map for planning a food rescue event, identifying locations and food quantities offered by suppliers;

FIG. 21 shows schematically a part of a user's dashboard detailing her various contribution;

FIG. 22A shows an example of the user's interaction one-clicks option a quick commitment where feed with personalized volunteering options match predefined-settings;

FIG. 22B shows the user's search task to volunteer in the tasks mapping explorer with regards to date, location, and type;

FIG. 23 shows a user's predefining search settings;

FIG. 24 shows a screen capture of a non-profit organization's community profile;

FIG. 25 shows a user's comprehensive interface with a user's personal profile;

FIG. 26 shows a screen capture of a user's personal profile header;

FIG. 27 shows a screen capture of individual user's contribution dashboard;

FIG. 28 shows a screen capture of buyer's search for product with priorities search setting for (purpose-driven) values preset user in the market interface, exploring the live-About-slip learn more on beneficiary.

FIG. 29 shows a screen capture of an individual user's store;

FIG. 30 shows a screen capture of an individual user's store, besides user's favorite's communities list and communities search map, exploring by activity types and locations;

FIG. 31 shows a screen capture of an individual user's interface for the edit options while the recommending system provides a product description adding a product to their store;

FIG. 32 shows a screen capture of an individual user's interface to the system's communication to use the system's price-recommendation services;

FIGS. 33 and 34 show a system communication to use the system's price-recommendation services;

FIG. 35 shows a screen capture of an individual user's interface for defining proceeds allocation when adding a product to their store;

FIG. 36 shows a screen capture of an individual user's settings, defining her locations and availability for the transportation and deliveries handover chain;

FIG. 37 shows a screen capture of pickup options suggested by the transportation and deliveries handover chain;

FIG. 38 shows a screen capture of a user settings availability calendar;

FIG. 39 shows a screen capture of details of tasks opportunities matching the users presetting for availability and preferences;

FIG. 40 shows a screen capture of a tasks map options presented to the user;

FIG. 41 shows a screen capture of an individual user's cabinet, as part of distributed community's storage, equipment assigned to organization, waiting for the handover storage;

FIG. 42 shows a screen capture of a commercial user's profile settings setup add-on widget to be integrated with external sites;

FIGS. 43 and 44 show partial screen captures of widget (Add-on) integration on a commercial user's external store;

FIG. 45 shows a screen capture example of a commercial company contributions dashboard presented as Add-on integrated with external website and the entity profile;

FIG. 46 shows schematically a dashboard detailing the contribution of a food vendor;

FIGS. 47 through 51 show screen captures of a local community's profile;

FIGS. 52 and 53 show screen captures of a municipality's dashboard;

FIG. 54 shows a screen captures of an event planning stage overview while setting up resources for a food rescue event;

FIG. 55 shows a screen captures of a contributing food vendor's dashboard;

FIG. 56 shows a login screen of a user, entry point to market, and to communities volunteering tasks searches maps;

FIG. 57 shows a summary dashboard of the food rescue event; the recognitions and see-through chain lead to activity growth;

FIG. 58 shows a products' tags including a QR code pointing to the seller's favorite communities and the way in which he allocates his revenues. The printable tag supports the run of on-premises sells

### DETAILED DESCRIPTION OF PREFERRED EMBODIMENTS

The present invention provides a deep social network, acts for continuous improvement supporting donations, volunteering, trade, payment, delivery management, reporting and distributed storage. The sustainable action-driven social network of the present invention is a global infrastructure. A unified ecosystem, bridging all aspects required to scale up social contributions. The system focuses attention on helping the individual to develop partnerships and be more active in his private life during his private time, or in any organization he is involved with. To develop social and green practices as a way of life. To coordinate all efforts and processes. To help the individual to bring himself in the most meaningful and effective way wherever we can take part. To fulfill our skills and expertise and manage our time better.

The system lays before us options, to bring ourselves to contribute in the most valuable, meaningful, effective way wherever we can take part. To better fulfill our skills and expertise, better manage our priorities and time, better understand the actions we take and better understand the influence and the bigger scope. To ease the process and improve the contributor's experience. The attention is on empowering the individual to create an aggregated impact, as the individual is the main decision-maker in our world. The platform supports the individual to make the best decisions on how to take positive actions. Aim to open the vision, the perspective, to remove as many barriers and plugs as possible, and to induce the individual to be more involved.

To develop volunteering habits and support each social entrepreneur to lead to success in a providing a supporting envelope for all needs. To help, social entrepreneurs and non-profit organizations with trust building, funding and volunteers' management, storage management, and cooperations with their own sector and other sectors. To help the commercial sector to better represent the social and environmental effort taking part in the organization and with the community. To help municipalities to grow the social doing and better interact with the communities. The system provides dedicated profiles to different entities—an individual, municipality, commercial, academic, communities, non-profit and charity organizations. To connect and synchronize all actual efforts in the public, business, academic and governmental sectors, and actors taking part in the global effort, to strive to act more effectively together in tackling the current common challenges in an ongoing changing basis. all while providing awareness of the actions that can be taken and the influence on the world's future.

System 100 assists with building strong communities, providing process management tool to assist with good cause activities and resources management tool to help identify resources and tasks management tool to get the community involvement with volunteering. enables breaking social events into tasks or action items to be performed by the user, taking into consideration mapping of the user's location, time, and social values, and matching them to the required activities. The process is turned into a sequence of data in which records are constantly updated and presented to the relevant entities. The social, environmental, and economic contribution of each action is calculated and presented to the various participating entities, preferably using graphic explainable tools. System 100 introduces a novel method of payment by donations to selected charity associations and/or causes and manages a distributed stock of donated products and services, thus reducing secondary storage needs; the goods are available locally and are supplied directly from owner to buyer upon demand, thus reducing transportation and helping global sustainability.

The system structured and acts as a neural network, with interconnected nodes in a layered structure derived from missions and entities requirements and processes flows, with focus on the real time activities management with continuous improvements, based on a deep learning process. The ongoing iterative process, the continuous learning aims to keep examining local activities effects, and more broad effects this data this technique uses to identify effective characteristics improved process to be able to provide flexible reactions to the dynamic of ongoing needs for changing. In different to the regular learning process where we can use training set and once converge, we can use the model finding to function well in a production environment, our scope is in an ongoing process in a live production environment where the flexibility requirements are to be able to improve in the dynamic of changing needs changing. This influences the system to act in an ongoing learning. Where partial learning from some cells that proved to excel may help to improve others and help processes to converge to achieve better.

The aspect of the learning process; The ability to learn from others' experience help to improve process and provide better results regarding achieving goals and building supportive communities. The system encourages all entities to adopt best performance practices. In this way we are exposed and share specific information to perfectly match the entity's needs where far community experience is propagated to influence others. This data analysis uses statistics and AI methods to extract the features, which are the effective patterns, processes or structures learned effects on the activities and process and score them and uses the information to improve these results by feeding the recommendations engines, to offer best practices to similar activities. For example, using a process template of food-rescue activity may break down steps in one community that was found to provide better time management and effectivity scores. Using similarity measures, the system may offer to other similar communities when setting-up new events, to adopt the process management template proved to excel in other similar activity managed somewhere else or a drill down to the highlight one specific part of the process steps may support an improvement. The recommendations system may find many processes start from training models that proved to excel, or a method and models and approaches that may use in far community and can improve others.

The system measures the local effect' and the influence of different cells in different scopes to learn patterns that may improve the sum of many activities contributions. For example, it may suggest adding another entity that proved to shape a stronger cell structure to a specific activity. may find that setting a reminder transaction to volunteers during the evening gets better results than during afternoon. The system may recommend small changes to a local entity on how to perform better based on contributors' feedback or evaporate valuable inputs to learn from far community activities: One community based in England and other in Norway. The system find similarity in their cells—its mean that they both acting in a similar structure shape towards the same goals, for example the mission is to get indoor entertainment based physical exercises activities to 3rd generation together with high school students. One of them get better participants attendance throughout the year and gets better feedbacks results then the other. The system will propagate best practices works to be recommended to the other. One of the emphases of System 100 is to provide forward and backward propagation to each system member as to the effect of their “small” contribution to the global ecosystem. The system closes the loop between personal, economic, and environmental profit and encourages competition by rewards calculated in a uniform and transparent way.
with the human-machine hybrid approach nature of the system, one important functionality in the ongoing reporting system supporting the transparency and decision making of each individual or entity, to again and again make the right decision if the entity functions well and whether to keep taking part in one activity or other. The power of making the best decisions whether to keep supporting entity to grow the activity and become part of a community, or to keep searching for better ventures to better match the skills, purpose or needs. The reactions and feedbacks of how the entity functions, together with the accumulative records-based scores on how attractive the entity is to the community members, together with content-based feedback, provide self-regulation qualities for each node activity. It helps to develop best matching teams, helps to stabilize the system; to prune inappropriate nodes' activity and to grow and empower others.

### The Deep Learning Problem Statement:

Achieving the society's common goals while maximizing society's contribution, maximizing effectivity with minimum loss.
Nodes: an activity-node may represent any activity, or any initiative run by any individual, one entity or more. It may be a single task or a complex event; it may represent a one-off activity or a recurrent one. Activities are aimed to be defined in the double how-to sense: one is to solve a problem, to grow awareness, to reach a goal, and the other is to grow resilience and develop the partnership of people involved in the activity. The attention is on personal experience, training, teamwork, and the sense of belongingness of each individual involved. Defining goals for both, outlining an implementation plan, interactions, and milestones along the way according to which KPI (Key Performance Indicators) can be measured. An activity-node may have inputs and outputs.
Entities: may be an individual, a charity organization, a non-profits organization, etc.
Inputs: are the effort and resources invested to support the activity node in achieving the output.
Outputs: are the activities' outcomes, influence, and results, and may refer to products, services, goals achieved. The output may be an aid or support provided by the node to a person or community or the environment or may be used as input to other nodes.
Channel: represent the interconnection between two nodes.
Weights: represent the amount of influence one activity-node has on another. It is the strength or level of contribution of a connection between two activity nodes. resources invested in each node. For example, time and effort of a volunteer, donation, funding invested in a specific organization or initiative
Cells: is a substructure in the network that incorporates a few nodes with typical shape, form of interconnections and flows acting together towards a common mission.
A layered structure: A layer in the invention action-driven deep social network, is a structure, or a sub structure network topology in the system scope of similar characteristic in the functioning entities architecture flow, may be nodes or cells or other scopes, which takes resources or output from the previous layers and then passes it to the next layer as input. There are several shapes of layers topologies as they characterize the functioning flow entities derived from process and dependencies between the entities involved in the activities, the layering topology derived from the real-life hierarchy of structure of the entities and activity and may be derived from the process flow, the influence and cooperations of entities, from the mission requirements, from local and global communities' structures and from regulation constraints etc.
The continuous learning process: The radial improvement process flow, is iterative and aims to supervise the activity in different regulations scopes. The iterative process of the feedforward and backwards together with the activation function, hand in hand with the requirements, goals KPI and performance and influence scores, aim to learn from one round and apply small changes on the next iteration feedforward. those changes have learned in the current round, or in respect to data collected of many early iterations and predicted to improve the outcomes of the next round. This hierarchical structure allows to define and learn from patterns of how different entities work together towards specific and general goals. The ability to examine entities' performances allows us to adopt successful models to recommend to similar communities or events.
Feedforward: represent all the efforts, and resources invested in the activities in one iteration of activity run.
Backpropagation: That backpropagation is a local learning process. Aim to learn on every activity when done, what need to be improved and what worked really well in order to tweak the process to better implement the changes for the next same activity run, to better achieve the activities goals with best sustainment of all parts involved. During the backward pass in which the chain rule is applied recursively backwards the recommendations to be able to affect all channels and nodes chained together effecting the way all part act and communicating to each other.

Every node in gets inputs as a resource and once the activity done, the post process stage is the system can compute two things: 1. its output value (sum up what was achieved) and 2. the local feedback gathered from all the activity contributors and beneficials involved the activity. To sum up all scores the system translated the data to an effective recommendations list with a breakdown of the parts of actions channels and nodes effective propagate the tweak the effects and their consequences.

The same process is done on various level of scopes to learn on how well a cell is functioning and propagate the recommendations in same way.

(Feed backwards) one aspect of the backpropagation mechanism is implemented with the “thank you”, the recognition on influence feedback, whereas every contribution made is recorded and gets live visual representation within the dashboards, this reflects the activities recorded in the system in respect to the contribution of each individual or entity together with the visual representation of the effort invested and the influence it achieved. This propagates the immediate feedback, can reflect the direct influence of the activity.

Each functional subsystem helps in supporting the sustainability-values implementation and the other functional subsystems with the management of a growing radial process. Each module serves as a gateway for the other modules and is cross-platform to serve different sectors.

Some of the functional subsystems are:

### Resources Management:

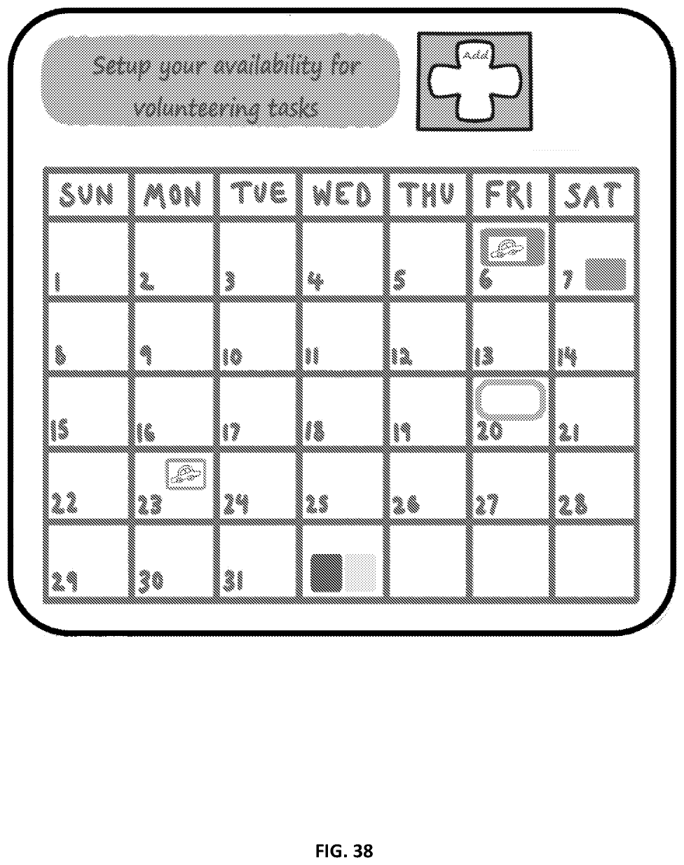

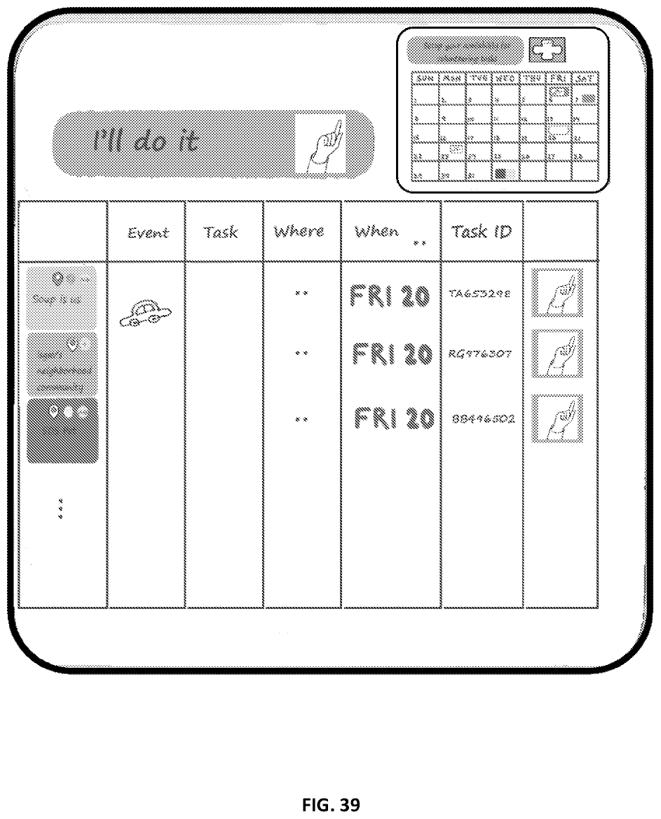

A. The user perspective: The system emphasizes the role of the individual in society. The attention is on the individual decision-making process, to assist with a better understanding of the needs and expose us to available tasks with special attention on to ease the user experience. To provide best user experience the system supports the approach of reducing to minimum all the coordination's hassle, in many aspects: for example, avoiding from overwhelming irrelevant request, the system, narrow down the incoming volunteering opportunities tasks transactions on the user profile feed, effectively managed, as its more personalized, where details of tasks opportunities matching the users presetting for availability and preferences (FIGS. 38 and 39). Furthermore, the effective communication, takes in account that time planning is a demanding and unpleasant task. Once the timeframe where pre-set and the only requirement is a one quick reaction, this synchronize and ease the critical commitment process and short the reaction in real-time manner with minimum interruption to the other tasks.
   The other way to effectively commit for a volunteering task, is by the easy to access explorers' maps. is one stop shop where we can find a task match to our availability, location, and preferences. The same with adding a requirement or resource or find a community or event. All records are up to date.
B. Process management tool:

The organizer or staff members can use the events management wizard, provide a range of tools and resources to support the organization's mission and operations: provide pre-defined templates to initiate, setup plan and manage and control states and steps mechanism. To define KPI's and choose measurements index methods. To get feedbacks and adopts recommendations on best practices; Its list of events and operations in different stages as: pre-process, planning, invite, ready, ongoing, done, post-processing (the learning process) and done-done. Each events record stored in database and every transaction and update is added to the event history logs. is registered in the database with all relevant data as: Event Id, date created etc., Stages can be manually adjusted.

The process of booking an event through the wizard typically involves the following optional states: (each state is following stages list)

“Pre-Process”: Define the mission and event type goals, choose the event type template process or create a new one of your own, choose the measuring method and KPIs, examine best practices recommendation to adopt, gathering requirements and resources: The user selects from the mapped-based options vendors and beneficials with respect to locations, dates, match the requirements and preferences the organization can support. Assign the staff and supervisors to manage and support the events.

Once provided all the Pre-Process definitions, changing the state to “Planning”.

“Planning” state: Will automatically generate a breakdown table: break the events into action items with respect to list the resources and steps required to run the events well: the system will help to Identify the skills and expertise needed: Determine the specific skills and expertise that are needed to support the cause or organization you are working with. Once the tasks list is ready Changing the stage to “Invite”.

The “Invite” state: will generate and distribute transactions to invite volunteers. will add tasks to the general volunteering options tasks map and will generate transactions to the suitable individuals preferred communication, platform together with transaction to their profile feed if match to their predefined availability, preferences locations, and skills. Once an individual has committed for the task, the task will be assigned to the individual (A communication channel with the volunteer's group will be available to provide volunteers with the support and resources they need to be successful in their roles. This may include training, access to necessary equipment or materials, and ongoing support.) once all tasks listed had assigned, the volunteers list the event state will automatically be changed the stage to “Ready”. The event is waiting for the scheduling time.

Once the event is running the event stage is set to “Ongoing”. The organizer will follow steps offered from the plan to best perform the running event. After all tasks has set to done Once the state changed to “Done”. The system recognizes and reward volunteers, and all contributors and calculate the performance and update, follow up and gather feedback: follow up with volunteers and gather feedback on their experience. This can help you improve the volunteer experience and better meet the needs of volunteers in the future.

The post-process is where the system analysis all the achievements and performance records to highlight best parts and provide recommendations to adopt for the next event.

Global values-driven circular marketplace: a circular economy market to support the reuse of products. implementing a circular economy to support social initiatives, crowdfunding, non-profit and charity organizations, and entrepreneurs, where we can use reused items to economically support ourselves, or by allocating a portion to our favorite initiatives or organizations. The market also enables the commercial sector to allocate a portion of the revenues for the benefit of the entity or individually chosen organization or cause. Free items can be assigned to a specific initiative or organization or to the public. encouraging products ease of reuse, and encouraging the decluttering process for social, environmental, and economic benefit. The economic engine employs the financial potential of our unused goods as an economic resource to ourselves or/and as support funding for good-cause activities. Where sellers can choose to help funding a good-cause activity while allocating a portion of the price to favorite organizations or initiatives.

Reusing items has a sustainable value as it helps with decluttering, reduces production, and give products a second chance, while being more affordable to the buyer and the seller.

We can enjoy a better selling experience of our unused goods with a recommendations system helping us to evaluate the product's value, to economically support ourselves, or allocate portions to benefit any favorite community, social event, initiative, organizations, or entrepreneurship (shopping crowdfunding). The shopper's searching experience offers to combine product and social values where you can prioritize the search engine to prioritize search results products according to social added value: support organization or initiatives matching your preferred social values. As a seller you can allocate portions of the price to your favorite organizations or initiatives or assign free-of-charge items to specific community contributors, initiatives, or organizations only, or to be available to all.

The global market enables the commercial sector to allocate a portion of the revenues of commerce for the benefit of their favorite organizations, social entities, or enable the public to individually allocate the portion to support their favorite organization or cause.

The circular marketplace aims to provide improved user experience whereas tackling few challenges associated with the Reuse market today:
A. The expenses associate with running an on-premises store and the management effort to run a store, make this funding solution not affordable for many small and medium organizations and charities and good cause initiative that are short of funding resources.

The system provides this funding envelope to fund all sizes of organizations or good cause initiatives for all sort of social entrepreneurs. A community or activity funding store will enjoy the funding by the system members' donations for their cause.
B. On-premises sales have small exposure, limited to the physically attending shoppers.

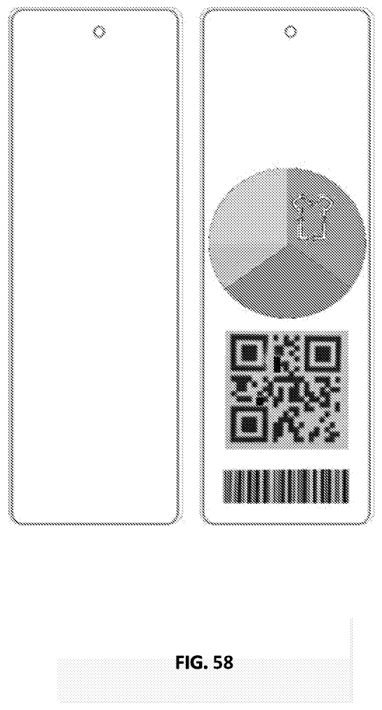

The system helps to extend the number of shoppers by real-time online and on-premises exposure that helps to ease stock management, where products' tags (FIG. 58) may include a QR code pointing to the seller's favorite communities and the way in which he allocates his revenues. Once done, the product is removed from the inventory. The system supports the first payer getting the product to support the online on-premises sync.

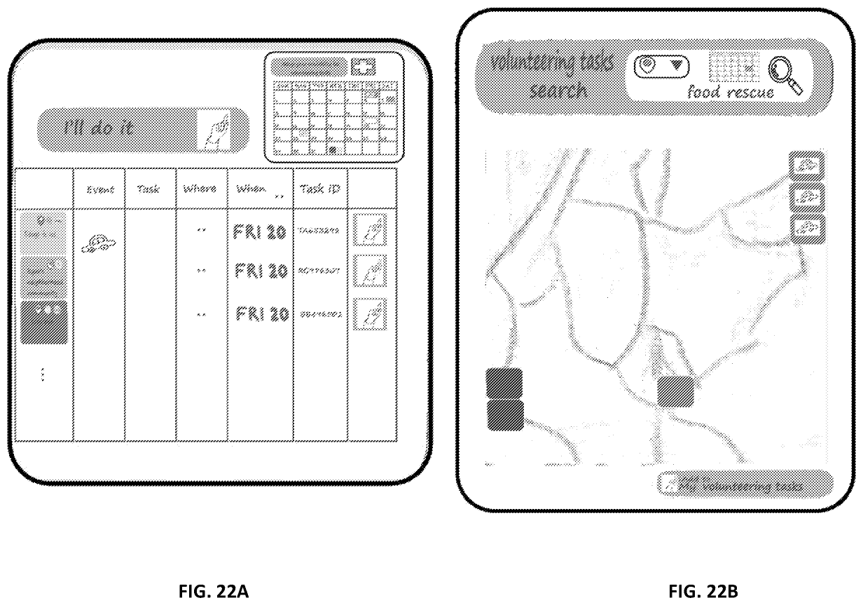

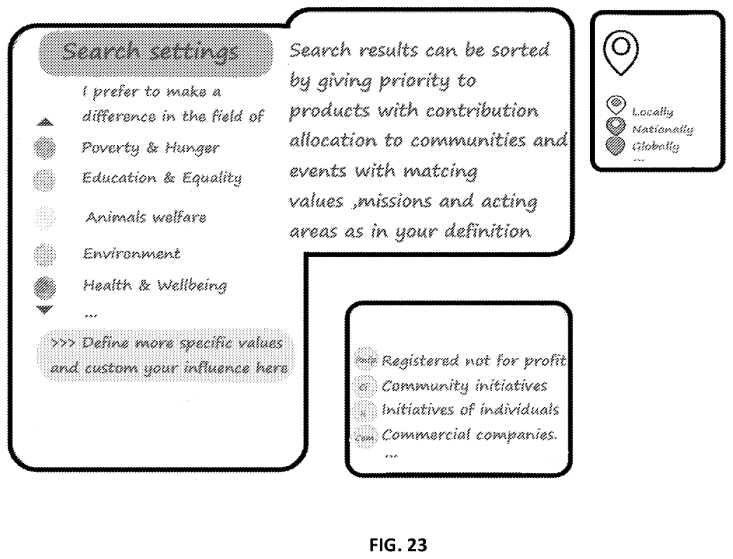

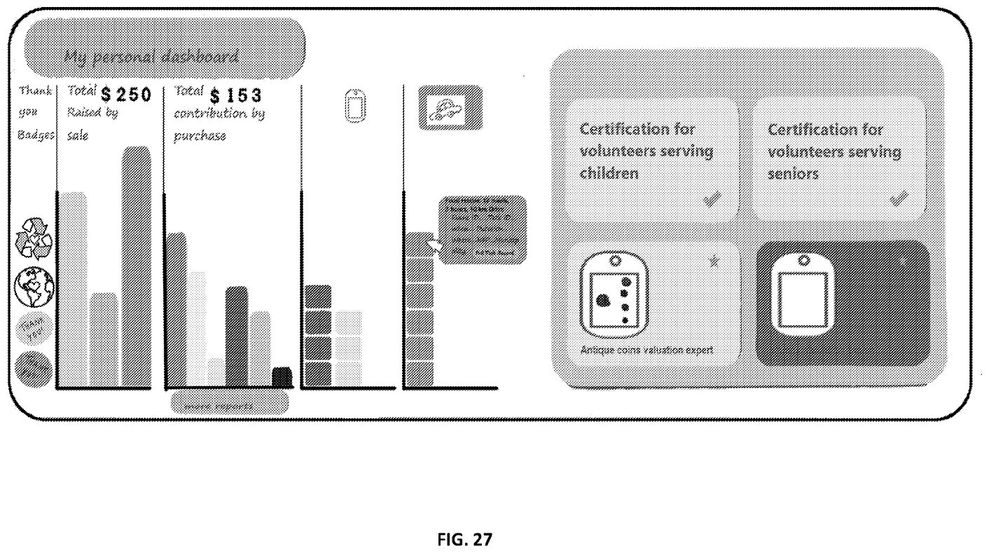

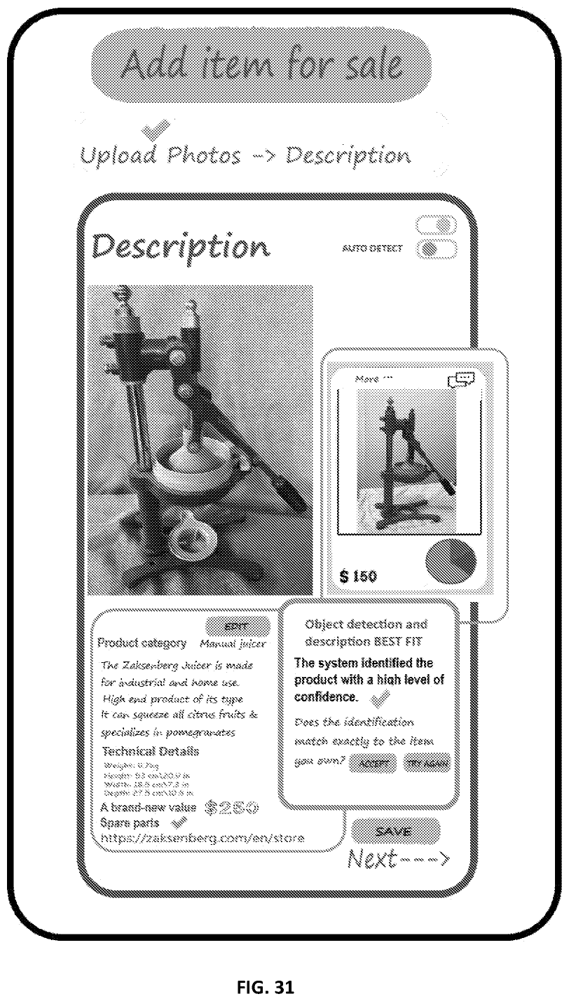

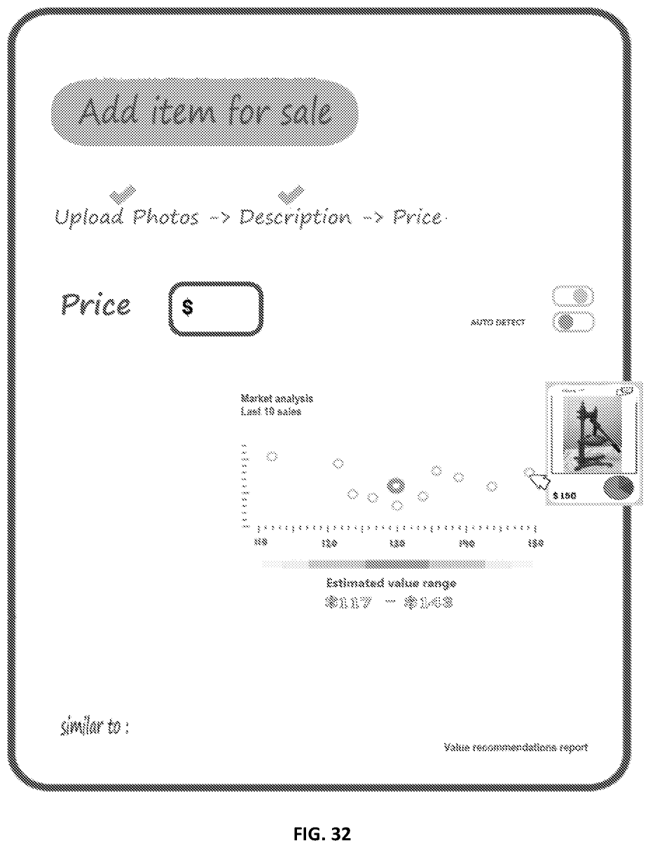

Every product can be ready for on-premises sale. Printing the tag will help on-premises shoppers to learn about the price allocation and support the payment process.
C. While the young generation have less behavioral inhibition related to trading on second-hand markets, older people may still feel uncomfortable or embarrassed due to a social stigma which associates second-hand trade with low socioeconomic condition. The system encourages trade by changing the situation and easing the user's experience by upgrading the traders' social status to donors. Dashboard with visual infographic present rewards, acknowledging the contribution made while trading for the benefit of the organizations and initiatives they support.
D. While the young generation have high presence and experience in online trading, one of the problematic points associated with less trained sellers is to assess the correct value of the goods they are offering. The process of learning the market value of goods may be time-consuming and sometimes frustrating. Wrong identification or description, under or over price estimation may lead to bad user experience. To ease the process, the system provides the seller recommendations support features to ease identify the product, a description and valuable data may assist with the sale (FIGS. 31 and 32) and estimate the product's value, provide the seller a market analysis report (FIG. 31), i.e. market analysis based on last 10 similar products sold, where you can get actual information on prices range and for each item, what was the selling price and how long it has been in the market. The system also generates a price recommendation based on the average selling price and average time the price has been in the market. You can accept this price or set another price; you can use the report to drill down to each item sold to learn details so you can decide and set the best-selling price. The recommendation system works in a hybrid mode, combining AI features with contributing community experts' assistance. Wherever the AI recognition system gets a low-confidence score, the recognition task will be handed over to the community experts and generate a recognition task transaction for experts. Experts may take a simple mission of product recognition or an expert mission of valuation. For example, a coin expert can assist with categorization and values of coins. Only coins experts will have access to the coin valuation tasks. Authorizations and expertise are part of the Resources management. Users may be recognized as experts based on their skills, profession, or hobbies (FIG. 27). Experts may get notifications to assist in their field of expertise. It may be a simple digital task or a more time consuming one. The system builds dynamic queues in which the tasks are awaiting response as part of the live tasks requests and mapping list (FIG. 22A and FIG. 22B).

The combination of AI tools and community human expert's valuation helps to build a stable reliable market. The system rewards all contributors for the product recognition and valuation tasks taken (FIG. 27).
E. Learn and share. Existing social organizations are not necessarily known to the individual. The market flow of the system may serve as a window for growing awareness on who is active, where, and why, and a gateway for learning, taking action or being involved with your favorite organizations, communities and other social activities.
F. There are some crowdfunding platforms where you can support a venture with donating a service or goods, but these many times appear in the scope of a small group, where as a donor you may find yourself choosing the worthiest option from the short list. In this way for this good cause, you may choose a good or a service that you don't really need. The sustainable market envisaged comes to enlarge the scope where you buy according to your true needs and in the same time support other good cause ventures.
G. Adopting eco-friendly practices encourage us to buy locally. It's less likely to shop from a geographically far seller. We often see goods we would like to buy based in far community where the seller is struggling to sell. The deliveries chain integrated in the market opens up the opportunity to support, far communities. as the seller can enjoy larger exposure to potential buyers, when, buyer can extend her local search to use the delivery and transportation chain. This extends your local search to the locations your contact visiting so you can enjoy the delivery chain buy like locally and support geographically far communities

The system offers an inclusive method in the width, as you may have great products, but your local shopping is now extended to support far communities and still remain eco-friendly. The inclusive methods enabling support of far community as you base your locations chain and enjoy your contacts
H. Add-on pricing gateway integration and API (Application Programming Interface). The system enables not only the internal market trading, but also enables integrating any commercial external entity to use the system's payment gateway to support the good cause entities and activities. This feature may be accompanied by an infographic add-on dashboard to reflect the contribution made. The system provides API to easy integrate the add-on to external digital real estate of the users, to promote their activities and empower them with exposures where their main customers traffic is done.

### Unified Sustainable Distributed Storage Management:

Some charity organizations have physical storage to serve the needs of the community by demand. Managing the collection of goods like furniture and the community transportation coordination, many time requires the ability to provide quick response, due to equipment donors circumstances, like moving house, or getting new furniture without backup storage options. When the donors do not have the right solution, equipment many times will end its life damaged on the street. A far warehouse facility will have high expenses in transportation, from the donors to the storage and again to the destination. To manage the storage stock in a more efficient transparent sustainable way, the system provides a solution by pre-defining when you required to pick-up the goods of last moment response. Storage management helps to better manage organizations and communities' equipment needs and stock availability can be better utilized by demand with a localization optimizer. Aim to reduce and better manage equipment donation process while doubling delivery and long storage efficiency with a local optimization needs and planning deliveries/mapping the needs, stocks with respect to location. The public can assign goods to a specific organization or need to be delivered by demand.

### Delivery Chain Management:

Reduce traffic while shopping by managed sustainable handover deliveries chain with the assistance of location which other users regularly visit.

You can define you location-search lookup to be based on your contact-based chain zone.

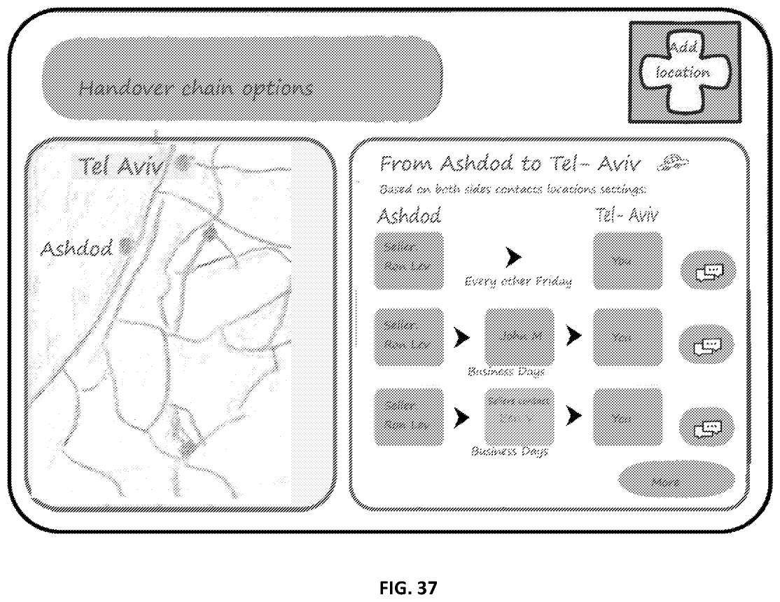

The delivery and transportation chain aims to reduce unnecessary travels, and to get the utmost from those doses. Making the added value of dropping-off or collecting a product to save time and effort of other users when possible. Due to the delivery and transportation chain, far community's seller may enjoy larger exposure to potential buyers, when shopping on the market, buyer can extend her search lockup for products out of her local zone and assist others with pickups next to her work premises or while traveling to far locations (FIG. 37). Once you required a delivery out of your local zone, this is the right time use the delivery chain options. Based on both ends' locations, the delivery chain system generates a delivery task, matches your personal contacts' deliveries definition, and provides you an optional handover list, based on your personal contacts, that are willing to assist with pick-up or hand-over deliveries with respect to the time frames and preferred time. With a one-click operation, you can now send a transaction, inviting the contacts you choose, and asking them to commit to the delivery task based on their predefined settings. There is an option to add the product and far-end details in the same transaction scope together with a 2- and 3-ways chat with access to all relevant task details of the i.e., product and seller to help you coordinate the necessary communication. For quick response purposes, the system may fetch a notification and minimal transaction to her favorites instant messaging or other pre-defined communication tool.

Once the delivery task has been completed the dashboard will be updated to thank you for choosing to use the delivery chain and of course will add the done task thank you to the deliverer dashboard and will add the relative second contribution infographic based on travel distance reduces.

### Records and Reporting Analytics Management:

Records management: The Activity Detail Record (ADR) utility enables to store and continuously update the status to view summary information about all transactions, events and tasks in real-time and stores them with respect to history by dates, locations and entities involved. Provides the option to retrieve partial or full information and archive it to a file, or internal or external reporting system or Database. The data can be used to produce reports or as a dataset to learn about effective features, trends and as part of the continuous improvement process.
Each activity is archived as a separate record and contains general information about the activity characteristics, such as the event name, ID, activity profile characteristics, start time and duration, as well as information about tasks occurring during the event, event managements details, location, providers, adding a new volunteer, removing a volunteer, or extending the duration of the event and more.
Profiles stored on the system as templates to manage and define all types of events required.
The records include all data collection and information about the activities running through the system to use as a resource to provide the raw source of data to be represented on dashboards and can be used for reporting and analyses, to better understand the impact based on real effort invested for an entity or the accumulated analyses in each scope required.
Dashboards: The Recognition Dashboards are live visual reporting for activity contribution rewarding, where each explainable trophy illustrates activity Records, and outcomes and link to the other contributors' dashboards. A dynamic real time dashboard is a visual feedback report for each user, profile, or entity (available internally or as external Add-on). Based on the real-time records collection (ADR): the dashboard is an easy-to-understand, visual infographic report, to sum up the activity done, and effort the current user or entity invested, provide the contribution summary with the option to drill down with Zoom in and out, Vertical and horizontal to follow and see-through: the transparent flow is based on the structure that each visual block represents a relative data structure or a relative record stored at the ADR. The infographic representation provides a chain of links to explore and follow traces, flows, and processes, to deeper view and learn about each task, events, donations, money raised through sale or purchase, expertise, trainings, organization involved and so on. In this way you can learn about the roles and contributors' performance and be exposed to the bigger picture. Whenever it is possible and relevant, the live board provides feedback analysis regarding key benefit result and influence achieved, with detailed breakdown regarding social environmental and economic goals.

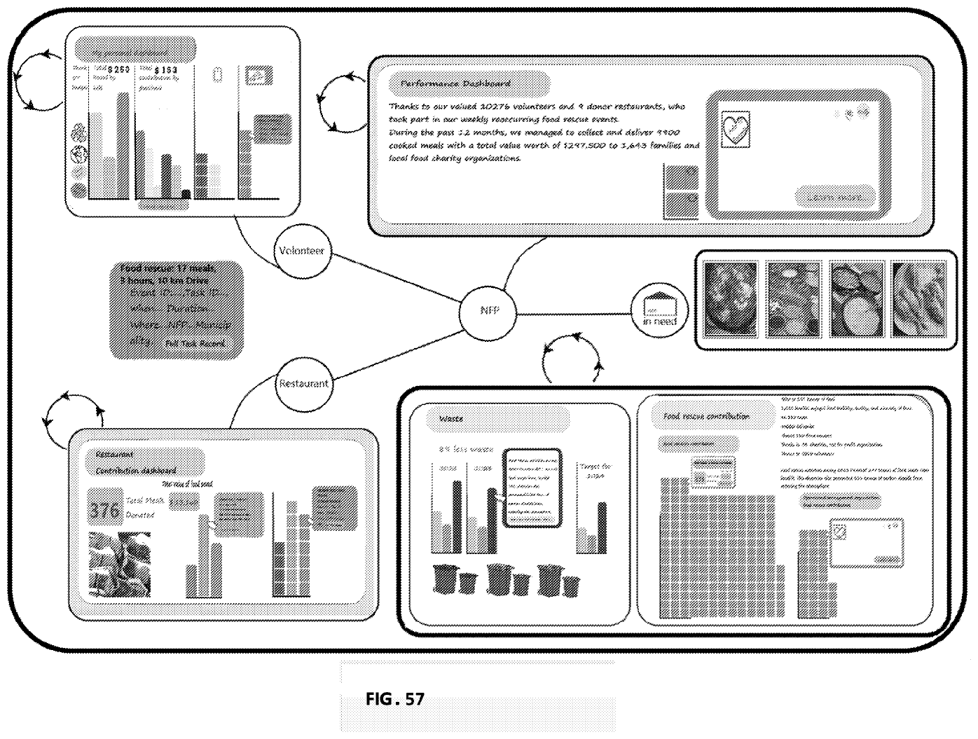

The contribution on the dashboard represents the activity results in two different stages: The first, referred to as the “activity contributions”, shows the direct influence and achievements represent and the basic activity records, related to the effort the volunteer or entity devoted to the activity. The second stage provides a wider view on the activity derivatives, the secondary influence, represent the added value, the additional growing effect the activity effected on as an outcomes chain, achievements of the related goals. This requires more complex analyzing and uses the subsystem measurement bridge. Calculate secondary influence, the activity records are translated to secondary influence based on standards indicators and indexes and raw data by the performance calculator. as shown in FIG. 57 in the context of the food rescue event, the secondary influence help to explain with quantified measures how the added value of the activity came with Diverted 297 tons of food waste from landfill. prevented 624 tons of carbon dioxide from entering the atmosphere. The importance of the explainable infographic that help to give baseline to compare carbon footprint reducing effort is a key aspect for the public to adopt more green practices. Offering local tasks may serve better the local community and is a priority as it saves time and eco-friendly reduced deliveries, it helps to build strong local communities. The same radial effect of dashboard exposure acts to grow activity as it acts in different ways: The thank you, the appreciation expression, is an essential part of the volunteering loop.

The activity “thank you” transaction is a collectable full of meaning credit point. Those are accumulated on your contribution dashboard. It is a visually quantifiable representation of activity records.

The contribution on the dashboard represents the activity results in two different stages:

The first, referred to as the “activity contributions”, shows the direct influence and achievements represent the basic activity records, related to the effort the volunteer or entity devoted to the activity.

The second stage provides a wider view on the activity derivatives, the secondary influence, there is an outcomes chain, achievements of the related goals. This requires more complex analyzing and calculations by the performance calculator as shown in FIG. 57

The dashboard sums up local municipality involved in supporting the food waste rescue activities. The municipality may receive a report that sums up all the records related to food rescue activities during 2023 within the municipality area, such as:
16,335 tasks
49000 deliveries
1,020 families enjoyed stability, quality, and diversity of food.
4080 volunteers
34 non-profit organizations
180 Food vendors

The secondary influence presented, calculated (1980) from all the records may be: Diverted 297 tons of food waste from landfill. This diversion also prevented 624 tons of carbon dioxide from entering the atmosphere.

The success of one municipality to represent the achievements builds a healthy competitive process supporting surrounding municipalities, to support their local businesses, communities, and organizations to take part in similar activities.

All entities and individuals who took part in the activities will get their “backpropagation thank you” with the secondary achievement dashboard update.

Some benefits and features of the dashboards are:
Presenting cores and other rewards reflecting activity done
Helping the user to explore and learn about the entity's contributors.
Exposure mechanism helps activity grow.

Data driven live report easy to learn and understand and supervise entities activities-transparency implementation regulation tool to develop accountability.

Unified measurements bridge: to effectively measure and evaluate the goals accomplishment and to support the current Measurements Gap: Data which has been effectively communicated can help to assess inequalities within entities, inform better decision-making and resource allocation at all levels, and provide the transparency that is necessary to hold all entities accountable for progress. The concept of measurements bridge is to provide one place where all the available standards, methods, models, and measurements indicators will be available to use in inclusive management approach. The Sustainable Development Goals are increasingly influencing how organizations, and governments are measuring and reporting their impact. The challenge these days is that there is a divergence of the process and there is yet no one unified standard that can serve as baseline to compare. Designing effective indicators is an ongoing evolving radial process that is not stable or deterministic yet and therefore different entities and experts may analyze the same data using different approaches, models, or interpretation. this may lead to a different outcome for their reports.

The unified measurements bridge sub-system's goal is to strive, on the one hand, to support all the different standards and indicators to evolve, to be able to help the entire global community to be exposed to the variety, to examine, learn and develop new methods, and still, on the other hand, aim to provide the most consistent comparable baseline in any timeframe. The two-pronged solution will support the process to converge faster and to provide more alignment, stability, and reliability. Where from the same raw data using the same recipe, the system guarantees a deterministic report as an outcome. The ability to compare different reports is an important feature that takes both data sets and recipes and may compare both with using one recipe, the other, a different recommended recipe, or a transformation table available to ensure the alignment for a fair comparison. Alignment of many reports will use a conversion table that takes all the reports and represents them in an aligned manner. Supporting different standards and approaches while evolving, is managed by a versions-controlled system that can represent a recipe taken to generate a specific report recipe (template) as part of the reporting system. The reproducible template trace can be valuable to alignment purposes for comparing verticals i.e., similar actions taken by different entities, or horizontal i.e., to reflect progress of the same entity. A recipe will provide a deterministic outcome to the same input.

Version controls: The version control enables breaking those standards and methods to subcomponents, and thus provides a flexibility by mixing and matching combinations, so that a report recipe can be built based on the richness available by the variety methods measurements, and yet can be reproducible and enable fair comparable baseline.

Evidence base reporting is always more trusted than assumptions based one, but the evolving situation is that there is yet not enough information on how to provide an unbiased report. The scientific community and many contributors are providing new methods and with the shared measurements marketplace the Ai measurement analyzer based on all records available to the system will provide:
1. Recommended recipes or sub-recipes for a specific record set. Based on the most closely related records that proved as the most successful at the current available recipe database. (The recommendation is available as part of the process planning in conjunction to the activity type, goals, and process template.)
2. As part of the continues learning tasks, conflicts and challenges need further investigation to highlight common issues required to be better understood, so that the effort can be more accurately prioritized and serve the global interest for further research, better representation. The common challenge Database will provide also list of tasks and requests for many other components that require a further investigation, i.e., a better visual representation to ease the explainable model for the system users regarding the influence measurement of a specific action or combination of actions. Those requests can come from the users' feedbacks inputs of i.e., the system process or from the AI analyzer conflicts detector. Grant, budget, or a price may be associated with a mission to find a challenge best resolution that may be provided with a relevant dataset for the scientific community of contributors.

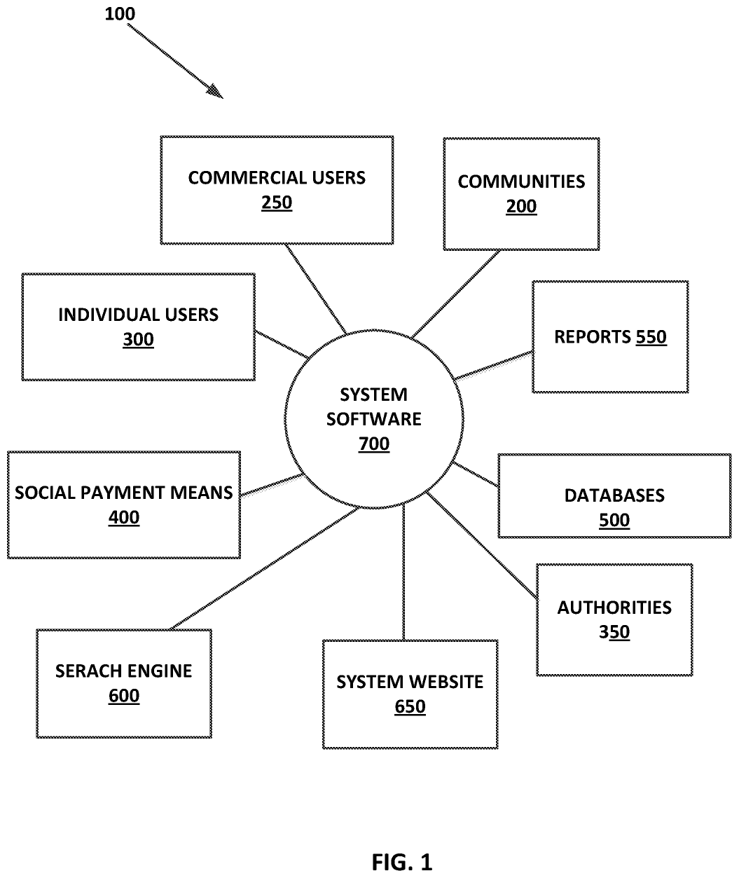

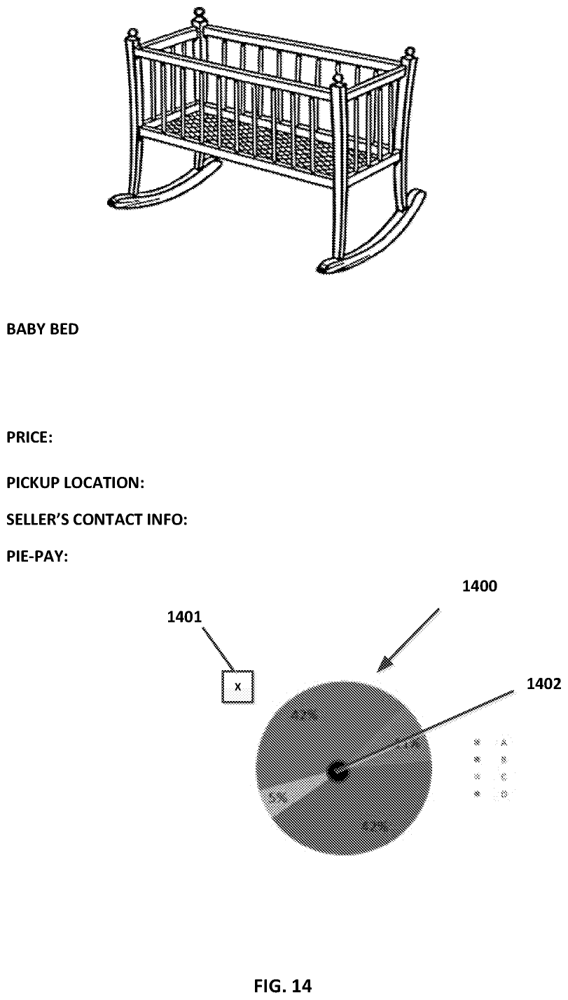

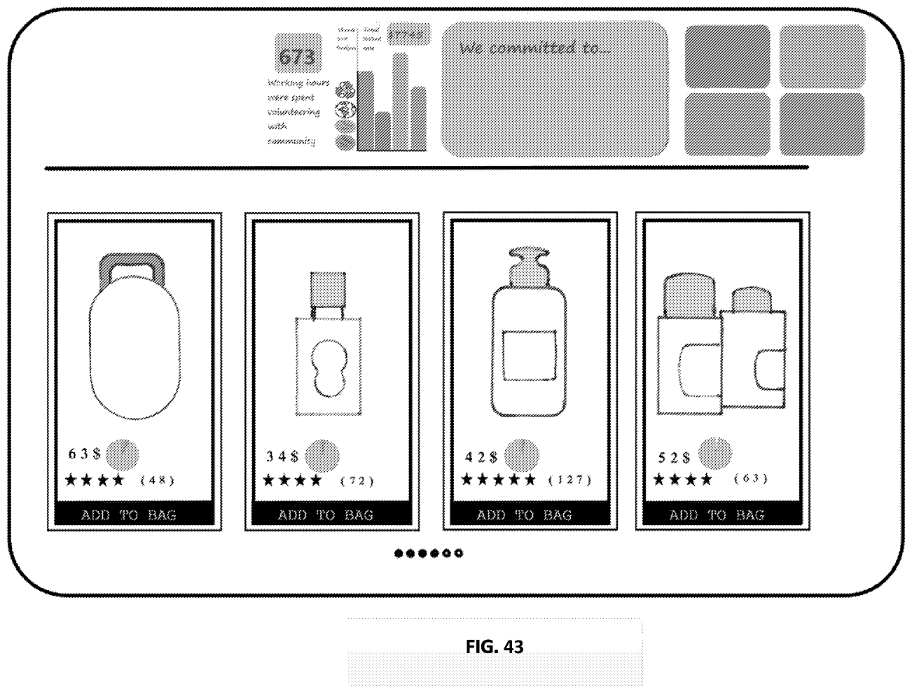

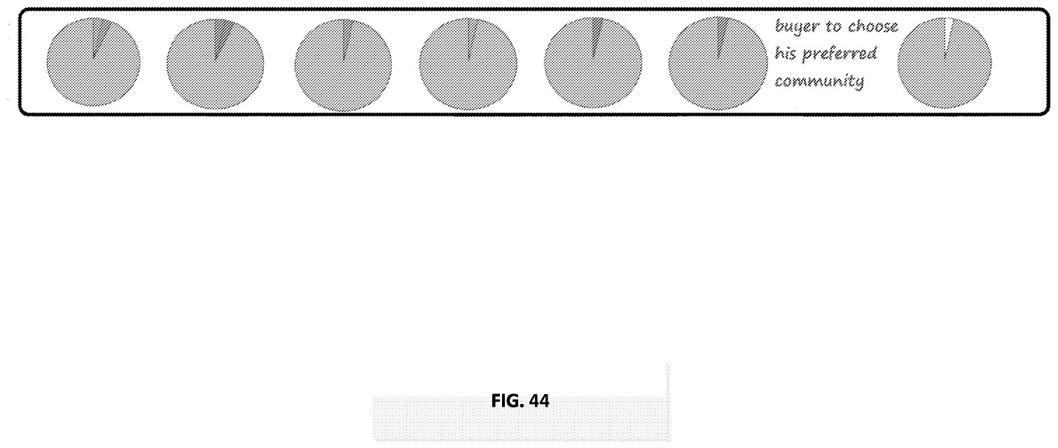

FIG. 1 is a block diagram of the main components of system 100.
Voluntary communities 200: A voluntary community may be any non-profit organization, public institution (e.g., school), or private entity, wishing to receive donations of funds or products for charitable causes. Each community is a registered system member. In the case of the community being a private entity, such as a temporary organization for a fundraising event, it may need a predetermined number of vouchers in order to operate as a community in the framework of system 100.
Commercial users 250 (See also FIGS. 43 and 44): Online commercial stores/producers who offer products for sale, wherein at least part of the payment is allocated to at least one of the communities 200. The commercial users are registered system members.
Individual users 300: Users who may offer products for sale or seek to buy products, wherein at least part of the payment is allocated to at least one of the communities 200. The individual users may be registered or non-registered system members.
Authorities 350: Links to municipal and/or national authorities' relevant departments on the internet, e.g. education, welfare, etc.
Social payment means 400: Novel e-commerce payment means providing payment options for the system 100 users, as will be explained in detail below, in conjunction with FIG. 14.
Databases 500: A set of databases comprising all the products, users, communities, and activities in the system.
Reports 550: A reports generator that provides reports to all system users and members, comprising social and sustainability goals achievement, current events states, and more. The reports generator uses graphic gamification techniques to enhance the reports.
Search engine 600: A proprietary search engine that may be searched by users who seek to buy products in the framework of system 100.
System website 650: A proprietary website comprising a portal for the various system 100 users and members.
System software 700: System 100 management and communications software.

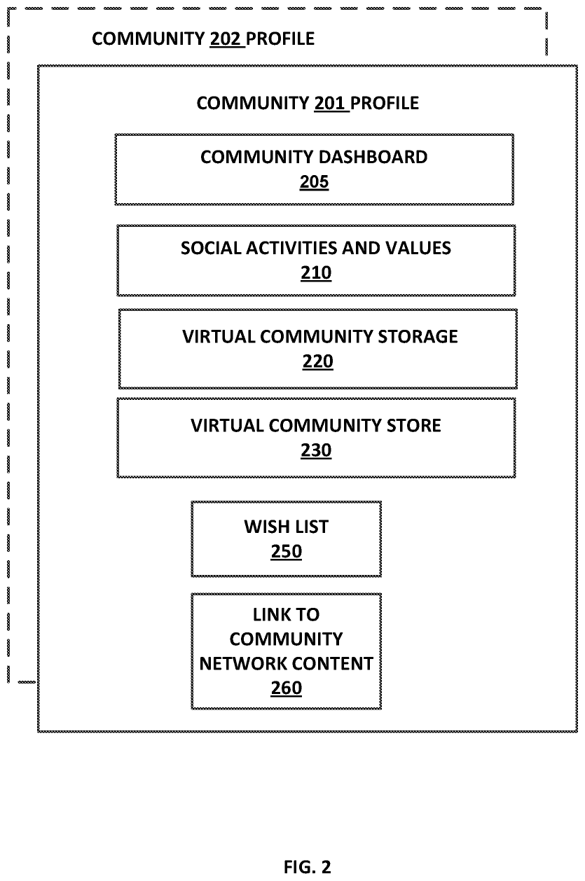

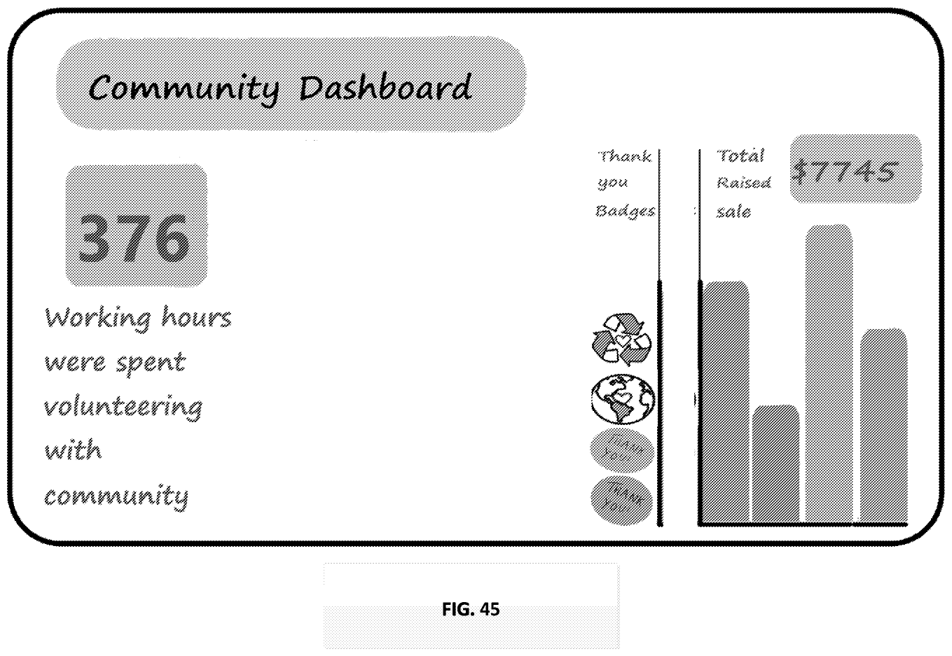

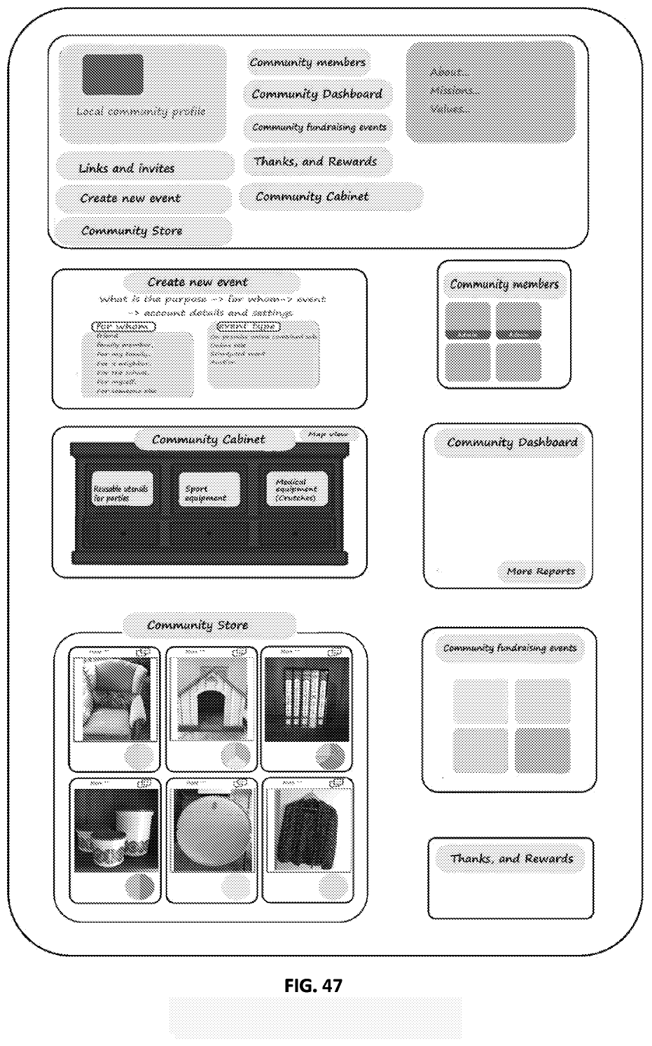

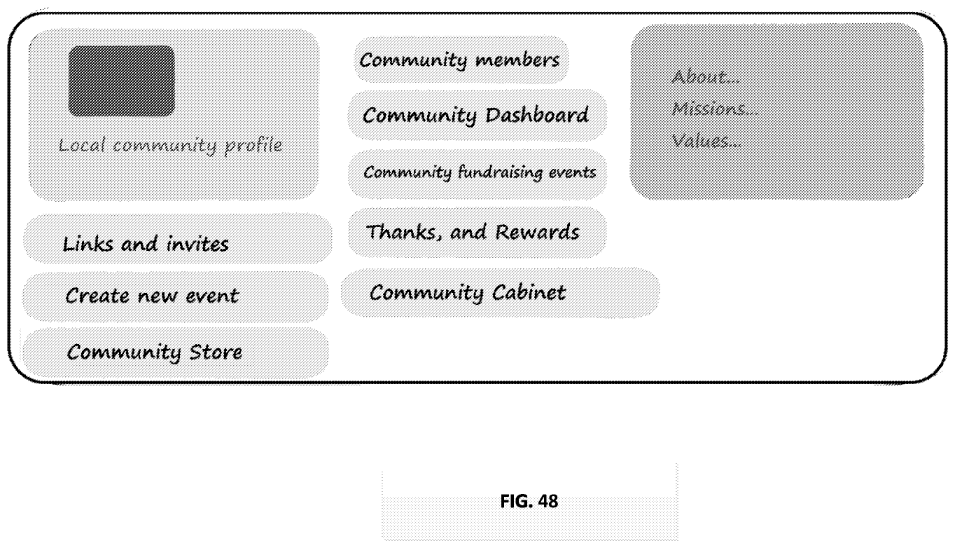

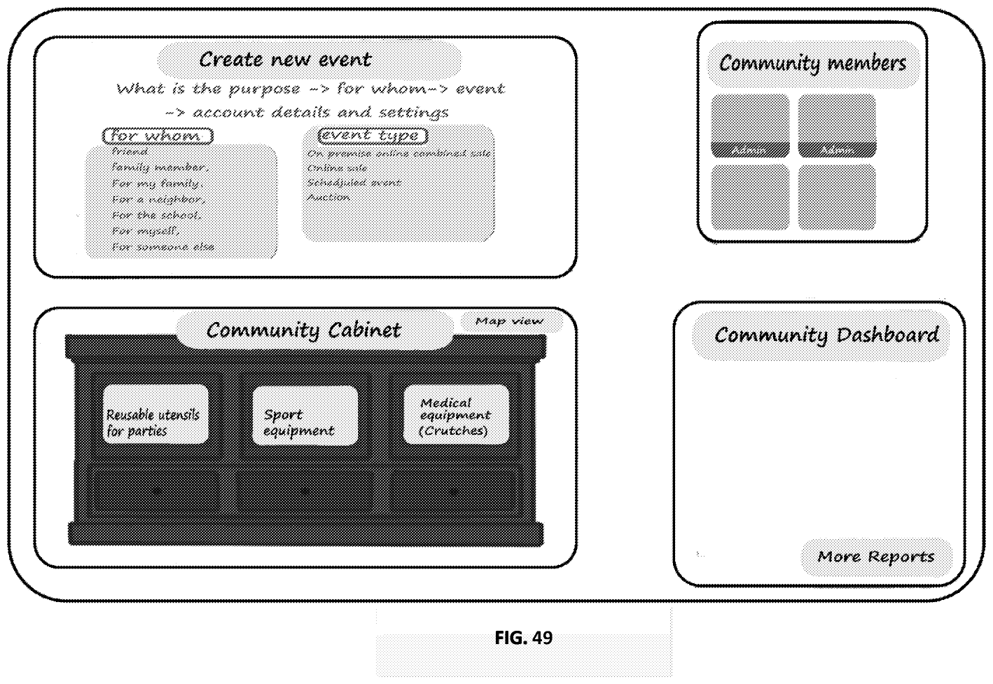

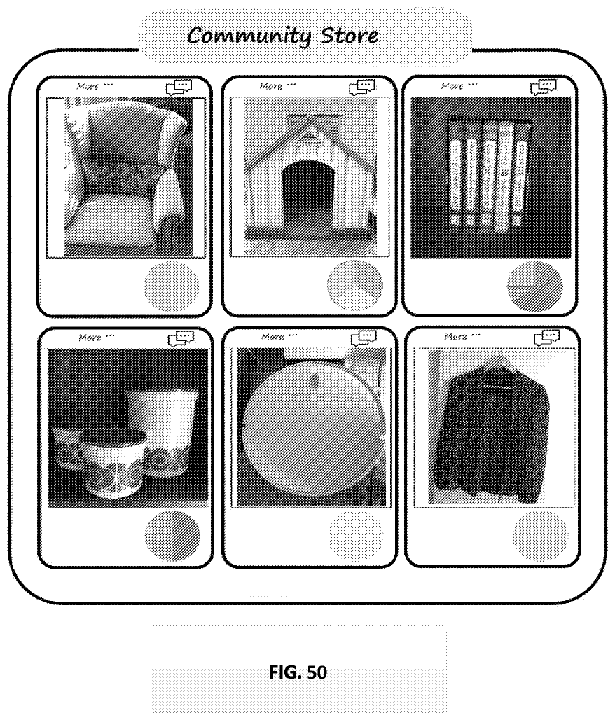

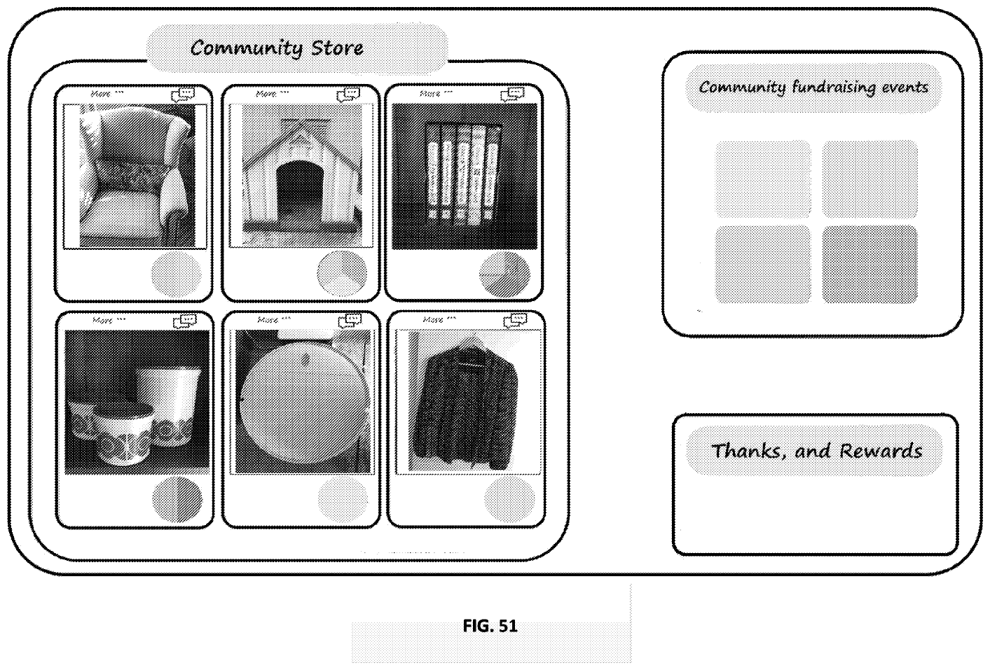

FIG. 2 is a block diagram of an exemplary profile of a community 201 in the system (See also FIGS. 47 through 51). The profile may be displayed on a dedicated community page on the system website. A community profile may comprise:
Community dashboard 205 (See also FIG. 45)—Infographic presentation of the community's activities and donations in the framework of system 100.
Social activities and values 210—The community's mission statement, which may include social causes supported by the community (e.g., feeding homeless people, aiding endangered youth) and social values (e.g., no experiments with animals, fair wages) of the community.

Each community profile header includes the ABOUT section; A brief overview description of the entity type, missions, activity fields, location scope, and services the entity provides. It provides basic information that visually describes the entity. the About is also the main flow entry point to the entity profile as it used the-live-About-slip, pop-out copy, far end representor, used as first impression representor to get exposure and a link, as an entry channel to the users to be exposed to the profile entity. live-About-slip is the first exposure to the entity.

The live-About-slip object activities may be:

“Learn more”: linked to Entity Profile. Open-up the entity full profile. It's a live entry channel and invitation to learn, get impression on how the entity performs invitation to become a contributor and get involved.

“Add to favorites”: This will add the entity to the individual favorite list, enable the individual to act as a contributor, with trade, with volunteering, follow activities, join the entity community activities and so.

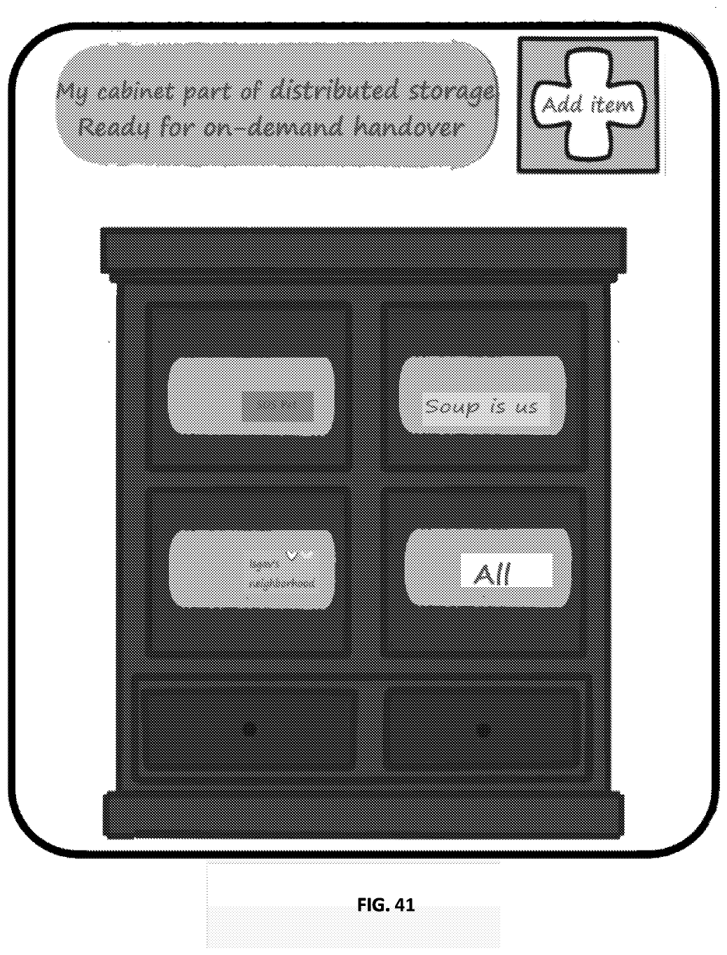

Examples for entity-types: RNFP: Registered non-profit organization, Ci: Community initiative, li individual initiative, Com: Commercial initiative and so on.
Virtual community storage 220 (See also FIG. 41)—A list of all the products currently being donated free of charge by users (250, 300) or by other community members to the community 201. System software 700 may comprise means for sorting the list by product category, name, geographic pickup location, etc. The physical storage of these products is distributed between the donators, thus reducing secondary storage and transportation needs. The products will be delivered upon demand, preferably by using the transportation and delivery chain.
Virtual community store 230—A list of all the products and services currently being offered for sale by users (250, 300), wherein at least part of the proceeds are dedicated to community 201. System software 700 comprises means for sorting the list by product category, seller name, geographic location, donation sums/percentage, etc.
Wish list 250—Community 201 may publish a wish list of products currently in urgent demand for its welfare causes, e.g., warm blankets. The wish list 250 is communicated to the system 100, which may further publish it to both commercial users and individual users of the system and to other communities. The community may also find urgently needed products in other communities' virtual storage 220 and/or virtual store 230.
Links to community networks' contents 260—Links to the community website, social media profile, etc. to enable users to receive further information about the community's activities and values and possibly become members of the community.

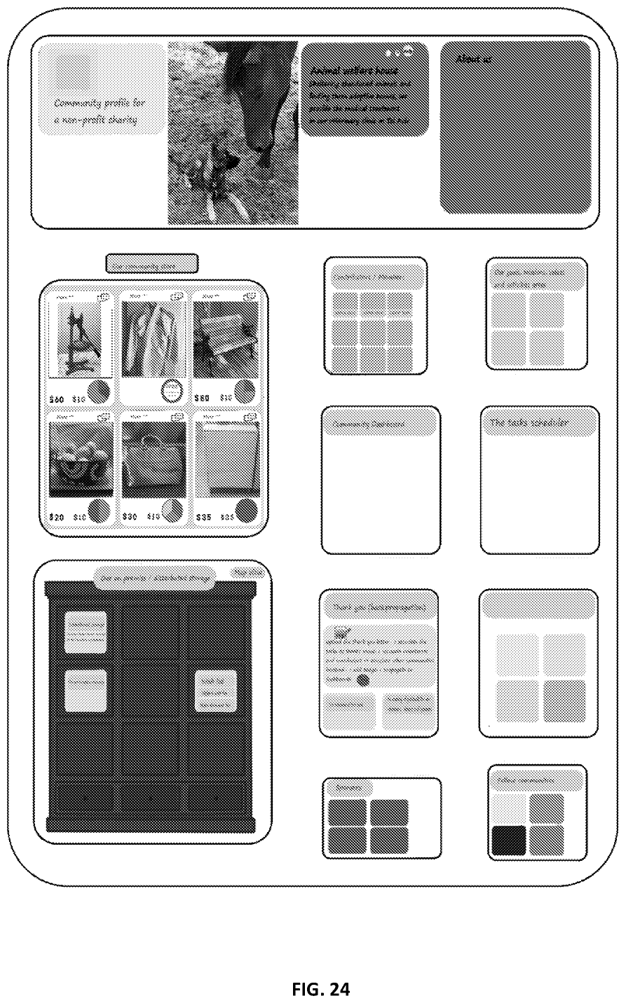

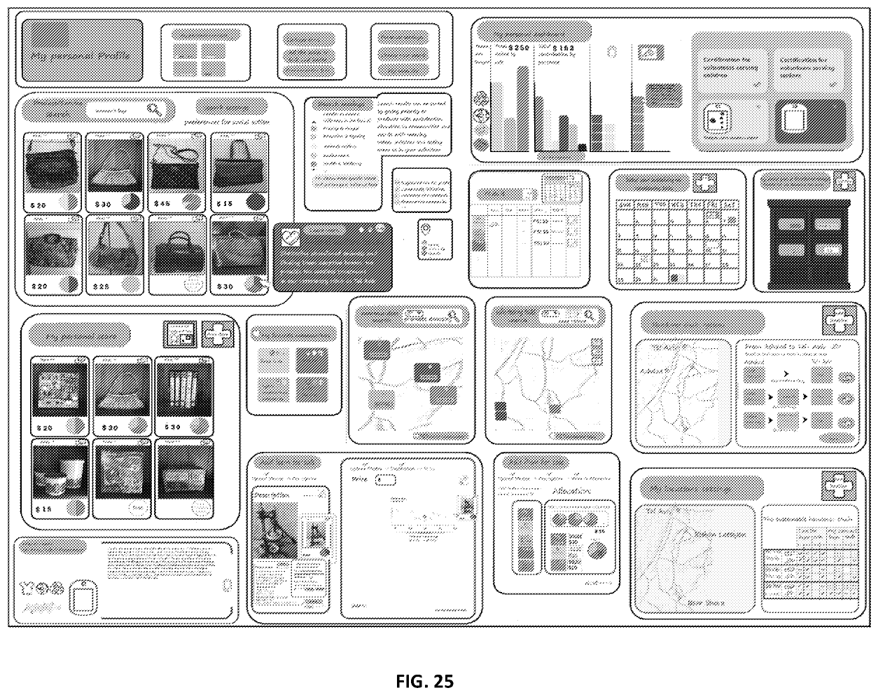

FIG. 24 shows a screen capture of a community profile.

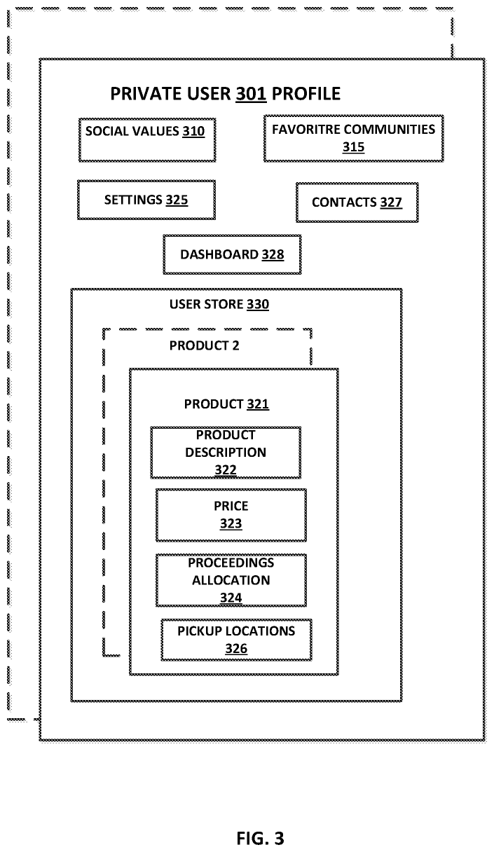

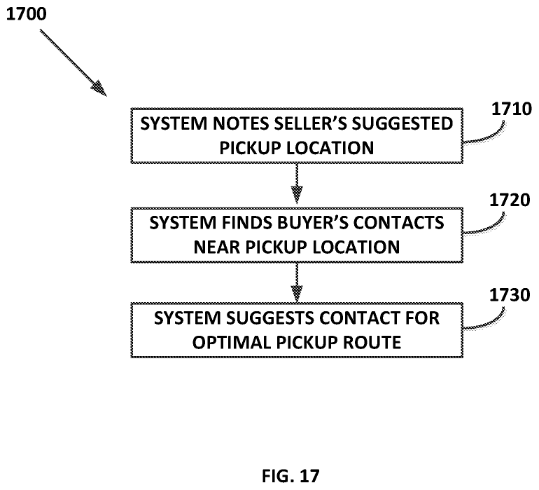

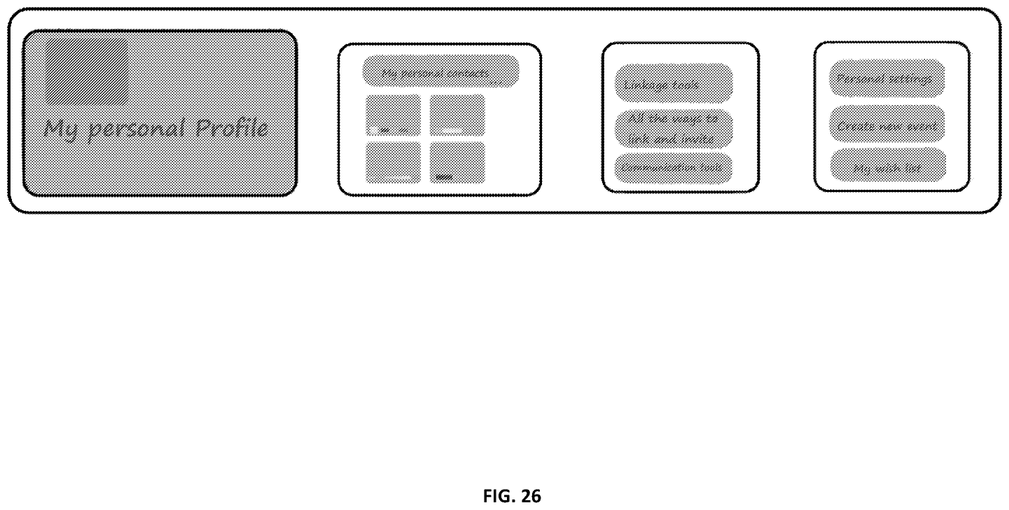

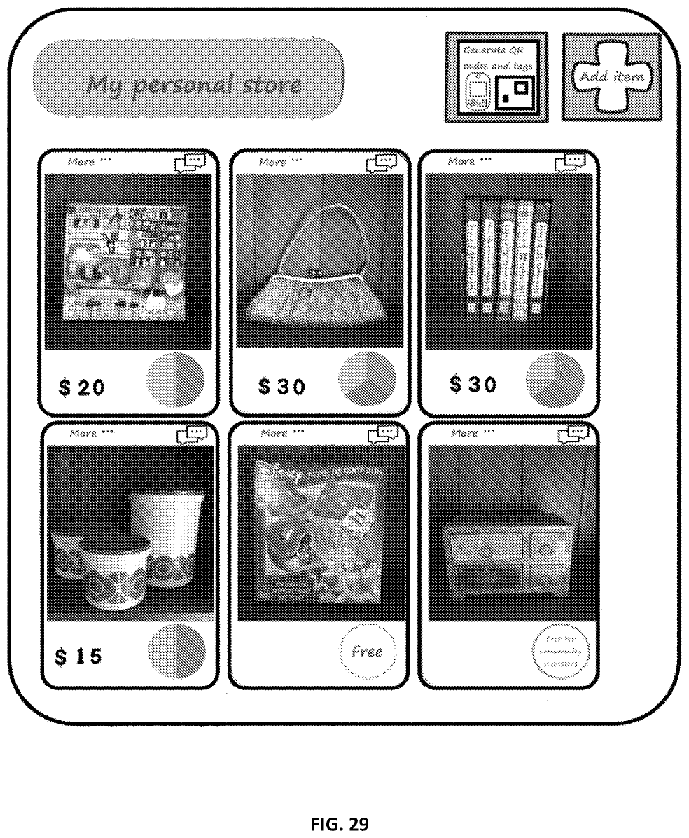

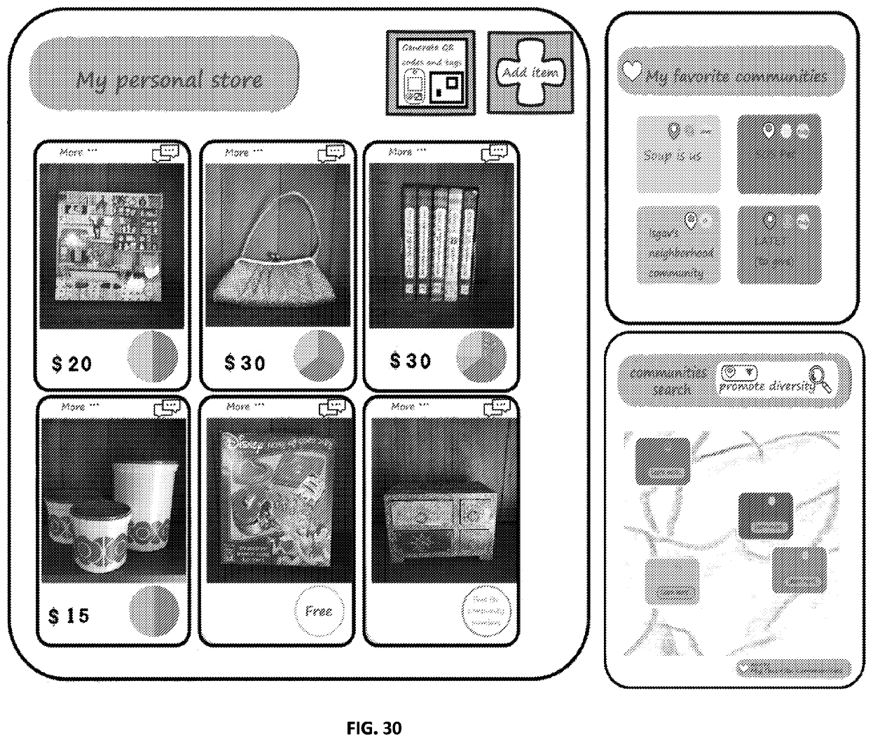

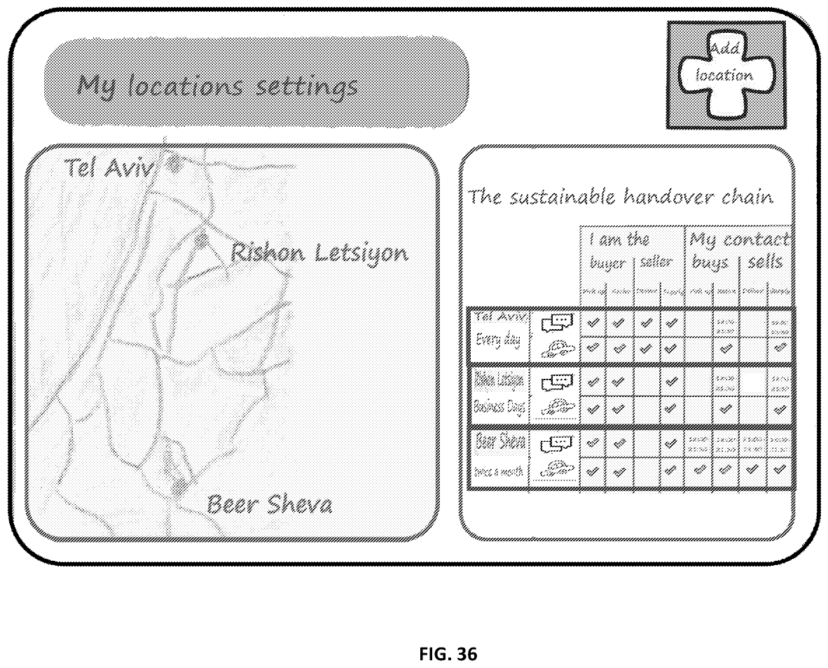

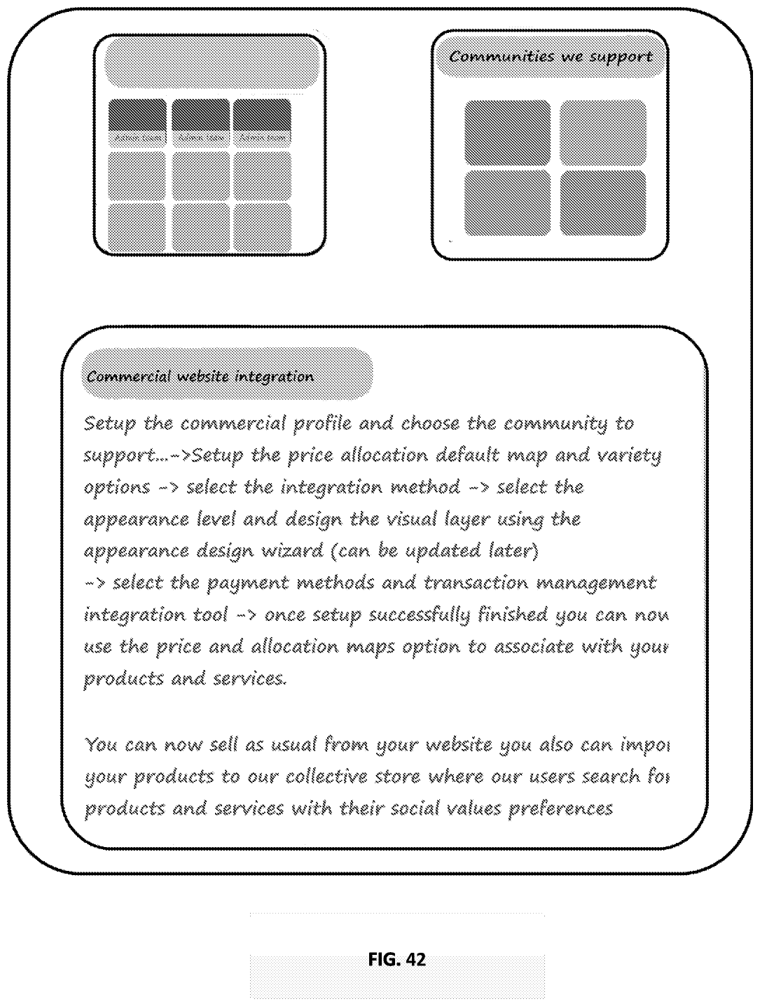

FIG. 3 is a block diagram of an exemplary profile of an individual user 301 in the system. The profile may be displayed on the user's page on the system website (FIG. 26). A individual user's profile may comprise:
Social values 310—A list of the user's social values 310 e.g., non-employment of children, no experiments on animals, helping homeless people, etc., proclaimed by the user or selected from a list of social values presented by the system, to be used by the system for matching buying requests with sellers' offerings and for suggesting relevant communities and activities to the user. The list is editable by the user.
Favorite communities 315—A list of the user's favorite communities as defined by the user or selected from a list suggested by the system in accordance with the user's values. Each community may be represented by its logo, its main activities, and a link to the community website. The list is editable by the user.
User settings 325—May include personal data, links to entries in social media (e.g. Facebook, Linkedin, etc.), money transfer details such as bank account (only required when products are offered), one or more default pickup addresses for products (e.g. home, work) and times/frequency of availability in these locations, and default fund allocation to one or more communities, defined by the user or suggested by the system, in correlation with her social values 310 (See also FIGS. 36 and 42).
User contacts 327—Links to the user's contacts in the system 100, which may be used for providing an optimal pickup chain route, as will be explained in detail below in conjunction with FIG. 17.
individual user's dashboard 328—Presentation of the individual user's activities and donations in the framework of system 100 (See also FIG. 27).
User store 330 (See also FIG. 29)—In the user store 330, each product 321 currently offered by the individual user 301 is described 322, both visually and textually (e.g., description, usage, state) along with its requested price 323. Proceeds allocation 324 and pickup location(s) 326 may be taken from the defaults defined in the user's settings 325, or may be defined by the user specifically for each product 321 (FIG. 30).

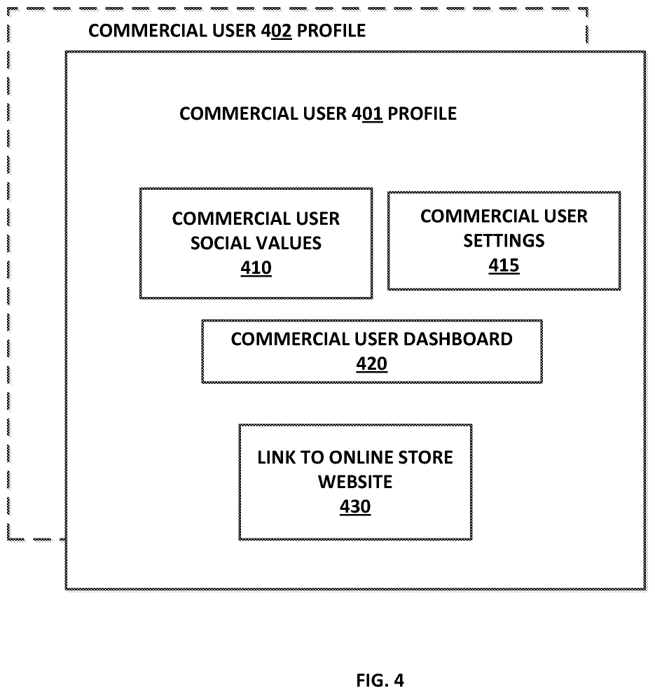

FIG. 4 is a block diagram of an exemplary profile of a commercial user 401 in the system. The profile may be displayed on the user's page on the system website. An individual user's profile may comprise:
Commercial user's social values 410—A list of the commercial user's social values 410 e.g., non-employment of children, no experiments on animals, helping homeless people, etc., committed to by the commercial user, to be used by the system for matching buying requests with sellers' offerings and for suggesting relevant communities to the commercial user. The list is editable by the commercial user.
Commercial user settings 415—May include personal data, links to entries in social media (e.g., Facebook, Linkedin, etc.), money transfer details such as bank account, business address, and default fund allocation to one or more communities, defined by the commercial user or suggested by the system, in correlation with the commercial user's social values 410.
Commercial user dashboard 420—Presentation of the commercial user's activities and donations in the framework of system 100.
Link to online store website 430—A link to the commercial user's online store.

All the above-mentioned dashboards and payment gateways may be implemented as software add-on widgets presenting a way to integrate external digital utilities to get exposure to the good cause activities. The system provides an API to easily integrate the parts and configure the process settings to support different features. The payment policies can vary and be managed directly to officers' accounts as the system provide the relevant data. or directly to the system. The reporting reflects any policy such as paying bank daily/weekly/by amount/bank transfer and transactions management system supports direct transactions or integrations with payments providers/transfer. The widget may be added, for example, to the website of a user, a community, or an authority, to present in a uniform way each entity's social, economic, and environmental contributions.

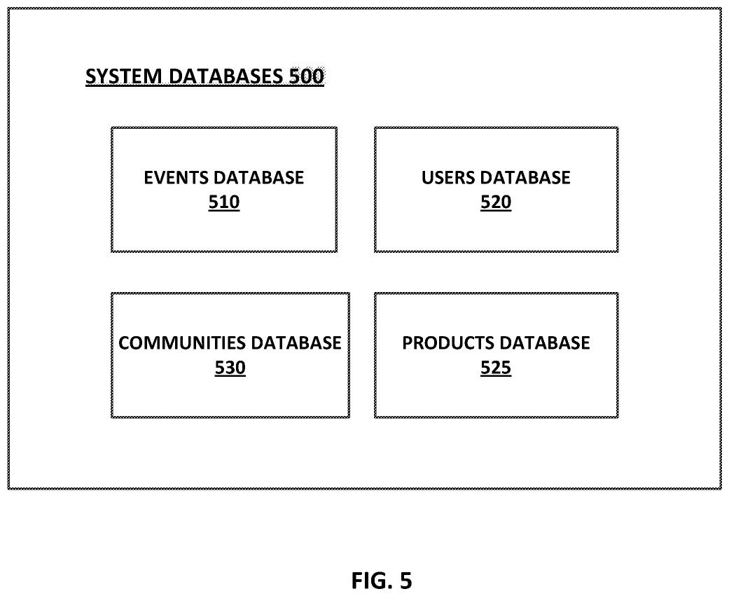

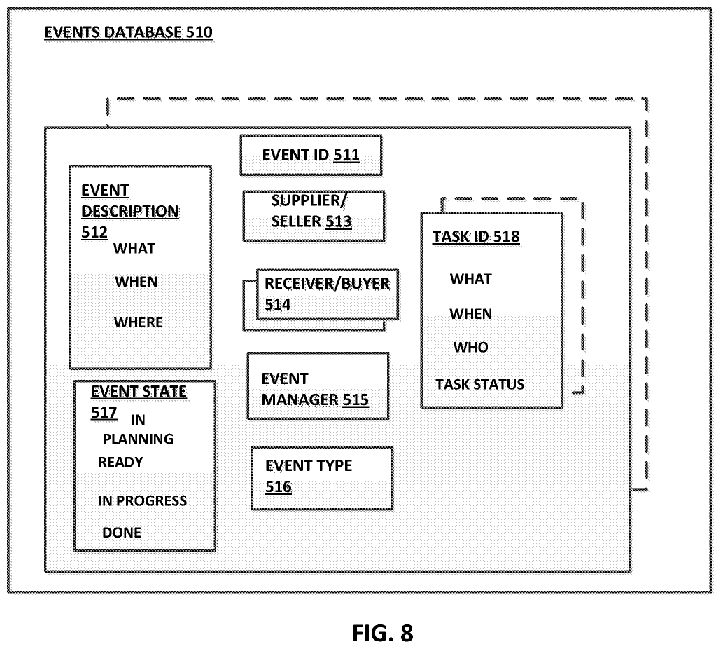

FIG. 5 is a block diagram of a number of databases used by the system to perform its various operations.
Events database 510—This is the main operational database of system 100, comprising details of all currently ongoing events, as will be explained in detail in conjunction with FIG. 8.
Users database 520—Comprising commercial and individual users' profiles, as detailed in conjunction with FIGS. 3 and 4.
Products database 525—Comprising all the products currently offered by system users (250, 300) and communities 200 in the framework of system 100.
Communities database 530—Comprising communities' profiles, as detailed in conjunction with FIG. 2.

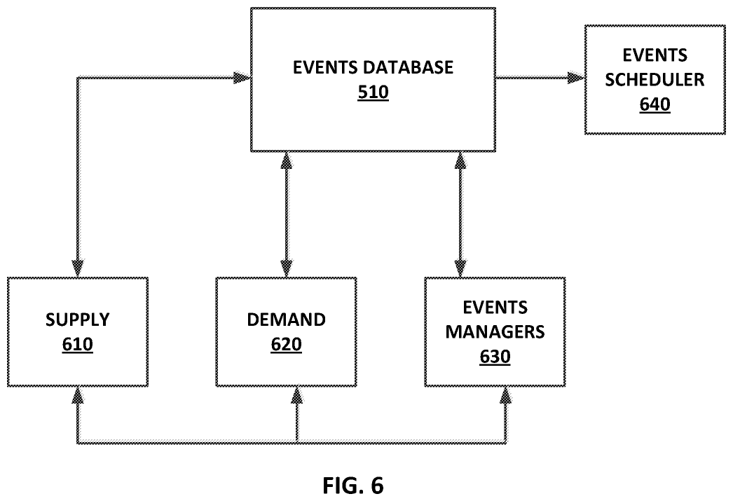

FIG. 6 is a block diagram showing the operational connections between the events database 510 and the various system entities cooperating in the activation of system 100.
Supply 610—All the products and services currently being offered for sale and/or donation in the framework of system 100. Supply 610 may comprise, at any given time, any or all of the products offered by individual or commercial users or communities, on their online stores (330, 430, 230).
Demand 620—All the products and services currently being requested for purchase and/or charity in the framework of system 100. Demand 620 may comprise, at any given time, searches done by users using the system search engine 600, communities' wish lists 250, etc.
Events managers 630—Managers of each current event, such as a community, an authority, or a user. The events managers are responsible for matching demand and supply, running the event, and reporting the outcome to each of the participating entities.
Events scheduler 640—A “blueprint” or template outlining the various steps required for planning and performing an event. The system provides the various events' schedules based on previously successful events of a similar type, using the system's learning process.

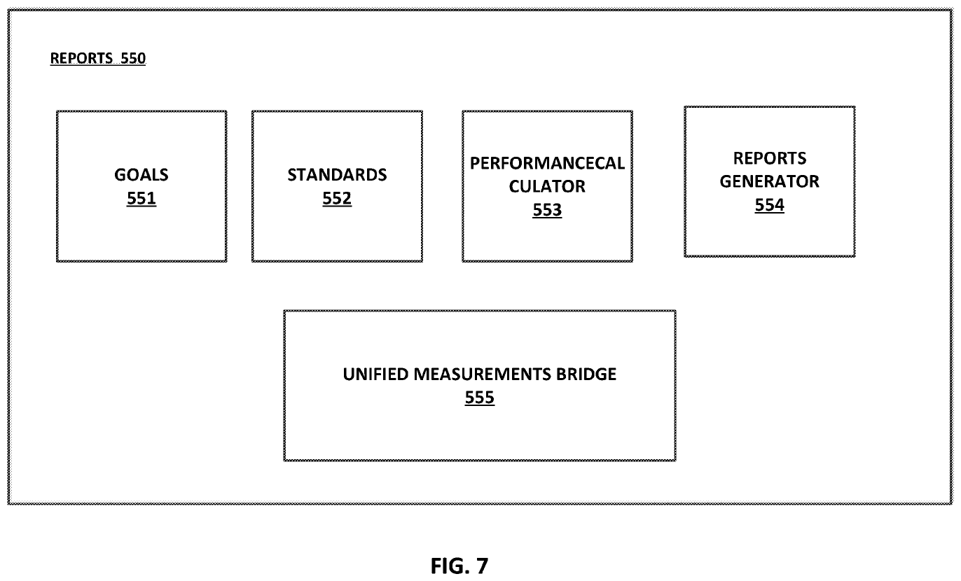

FIG. 7 is a block diagram of the reports module 550. The reports module comprises goals 551, such as social, environmental, economic, etc. Goals 551 may be based on international standards 552 such as ESG (Environmental Reporting Guidelines), ESF (Environmental and Social Framework), NAAQS (National Ambient Air Quality Standards), and others.

Performance calculator 553 calculates the compliance results to the goals, achieved by each event, task, and participant, using techniques provided by the various standards selected by the event managers (or a default standard), and the reports generator 554 generates suitable reports for each of the event's participants. Unified measurements bridge 555 effectively measures and evaluates the Sustainable Development Goals (SDGs). The concept of a unified measurements bridge is meant to provide one place where all the available standards, methods, models and measurement indicators are available for use, and provide a common denominator (conversion template), while retaining the original measurements (reproducible template) for future research purposes. Data that is uniformly communicated can help to assess inequalities within countries, help better decision-making and resource allocation at all levels, and provide the transparency that is necessary to hold governments and organizations accountable for progress. The reproducible templates can be valuable for alignment purposes for comparing verticals i.e., similar actions taken by different entities, or horizontals i.e., to reflect progress of the same entity. The unified conversion template provides a deterministic outcome to the same input. FIG. 8 is a block diagram showing a detailed description of an event entry in the events database 510, comprising:
Event ID 511—a unique ID allocated by the system 100.
Event type 516—selected from a list of event types such as, for example, food distribution, product sale, product search, offer of services, etc. The list is provided by the system and event types may be added by communities and/or authorities.
Event description 512—including “What”—e.g., “Restaurant FOODY is offering leftover food”, “When”—date and hours, and “Where”—food distribution address.
Supplier/Seller 513—including a pointer to the supplier's profile in the system and/or a link to the supplier's website, e.g., FOODY's website.
Receiver/Buyer 514—including the receiver's profile in the system and/or a link to the receiver's website. The receiver 514 may be one of a number of volunteers who offer to participate in the event, e.g., collect and deliver food.
Event manager 515—points to the profile of the entity responsible for the event, which could be a community, an authority, e.g., municipality, or a single user. The event manager 515 is responsible for defining the event, assigning tasks, and following/updating the event's state.
Event state 517—such as “in planning”, “in progress” and “done”.
Tasks—are defined for the event by the event manager. Each task includes a system allocated ID 518, specific actions to be carried out, such as “What”—e.g., Collect 10 boxes to be distributed in Tel-Aviv”, “When”—including date and activity hours, “Who”—points to a specific volunteer who fits the criteria, and “Task state”—such as “In progress” or “Done”.

According to embodiments of the invention the event's template may be laid out by the system scheduler 640.

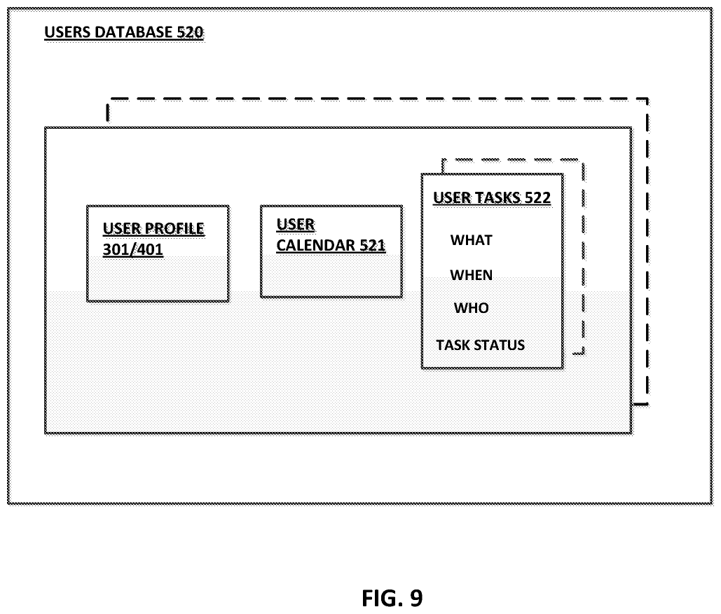

FIG. 9 is a block diagram showing a detailed description of a single (individual or commercial) user's entry in the users' database 520, comprising:
User profile 301/401, as detailed in conjunction with FIGS. 3 and 4 respectively.
User calendar 521, which may be used by the system or by the user to coordinate tasks during an event planning (See also FIG. 38).
User tasks 522, including details of tasks currently involving the user (See also FIG. 39).

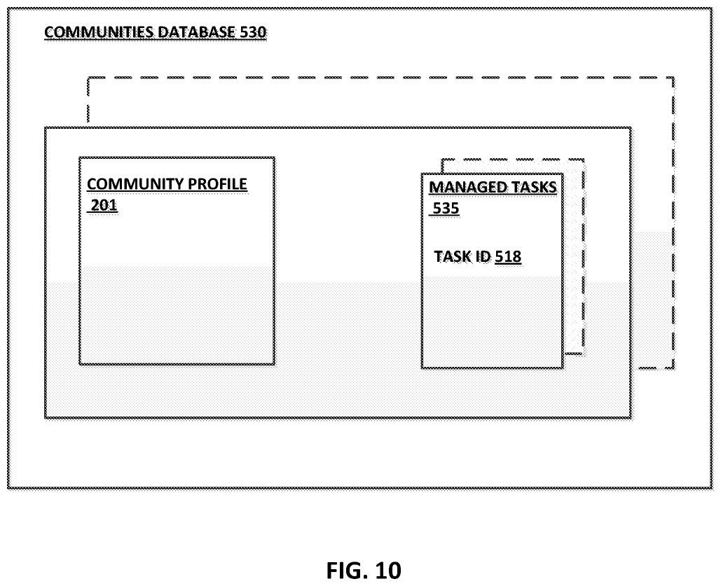

FIG. 10 is a block diagram showing a detailed description of a single community's entry in the communities' database 530, comprising:

Community's profile 201, as described in conjunction with FIG. 2 and tasks 535 currently managed by the community, addressed by their task ID 518.

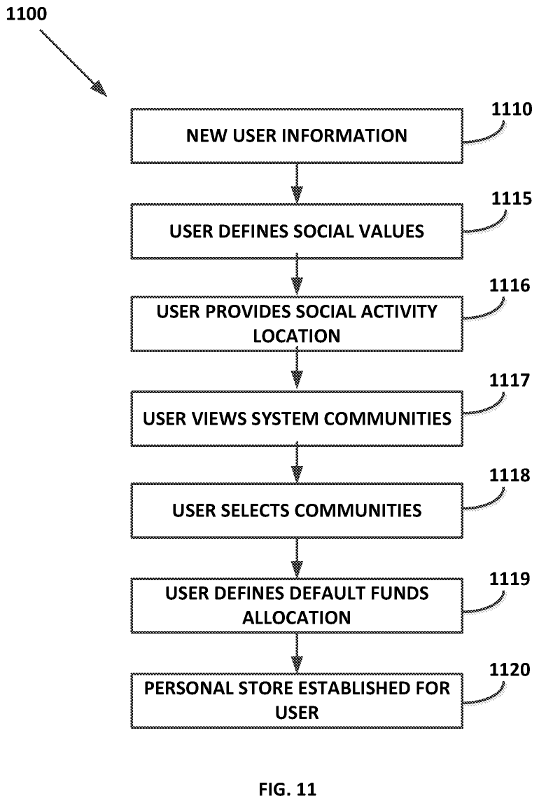

FIG. 11 is a flowchart 1100 showing the process of a new user's registration to the system. The new user may be an individual user 300 or a commercial store 250. It is suggested that the order of steps is not binding.

In step 1110 the new user enters the system portal and provides requested information such as name, address, username and password, default pickup location(s) and times, bank account details, and any other personal information such as links to social media, to create her user profile.

In step 1115 the new user compiles a list of her social values (may be selected from a list of social values presented by the system), to be used by the system for prioritizing buying requests of the user's offerings and/or for matching other users' offerings to the new user's buying requests.

In step 1116 the new user may specify geographic locations where she prefers her favorite social activities to be conducted, e.g., Manhattan, Europe, South Tel-Aviv, etc.

In step 1117 the new user may view all the communities 200 registered to the system and drill down to the community's profile and network contents, to view each community's social values, social activities, members, financial information, etc. The system may present a short list of the communities most correlated to the new user's social values and profile.

The system may present the user with a geographical map showing the correlated communities' activity locations and possibly other communities active in the preferred area. The map may be zoomed in or out.

In step 1118 the new user may select one or more of the system's communities 200 as the default communities to which she wishes to donate proceeds of the products she offers or to volunteering activities/time. The user may also use the map to select other communities to add to her list of favorite communities.

In step 1119 the new user may define funds allocation between the selected communities, to be the default allocation when she offers one or more products for sale. The defined funds' allocation may be presented to the user in a graphic form, such as a pie chart or diagram, using system-allocated colors or patterns. The colored/patterned areas may include links to the various communities' websites or system entries. Hovering over a colored/patterned area may present a short description of the community's activities.

In step 1120 a personal store 330 (initially empty) may be established by the system for the new user.

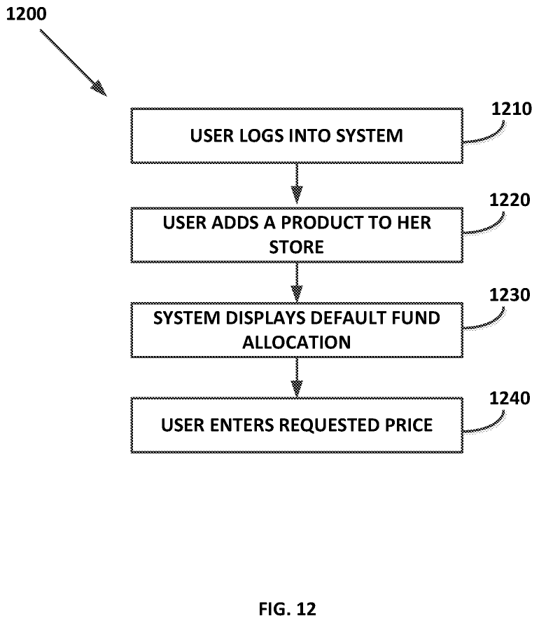

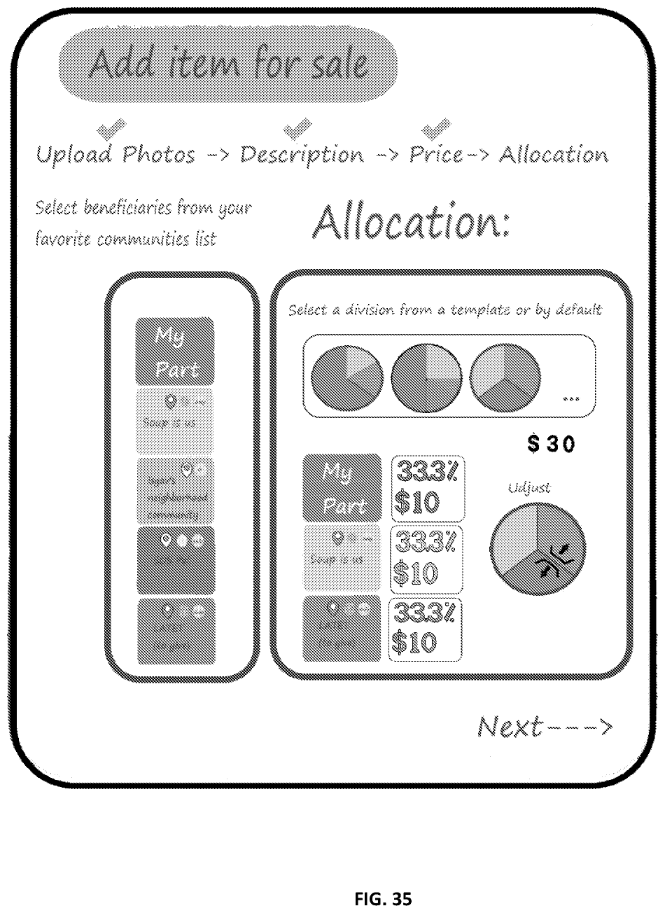

FIG. 12 is a flowchart 1200 showing a registered individual user 301 operations for adding a product to her store 330 (See also FIGS. 31 and 35).

In step 1210 the user logs into system 100 using the username and password defined upon registration.

In step 1220 the user may add one or more products (mostly 2nd hand) to her store 330. Each added product 321 is accompanied by a picture and preferably some descriptive text.

In step 1230 the system automatically displays the user's predefined default pickup address(es), which may be modified by the user, and the user's default funds allocation, which may also be modified by the user, either in a modified percentage allocation between the selected communities or in adding/deleting a community from the proceeds.

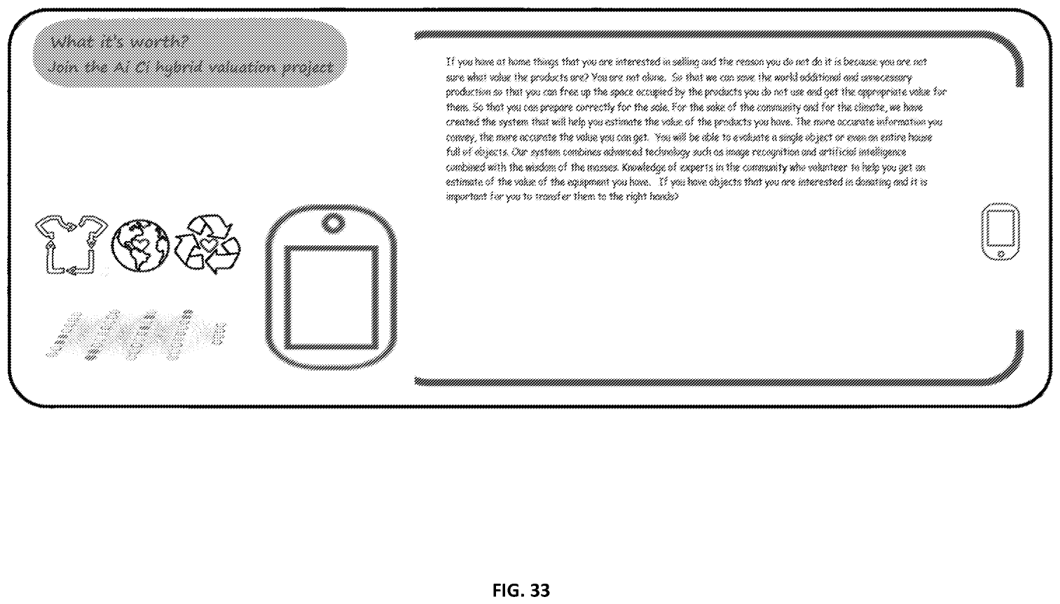

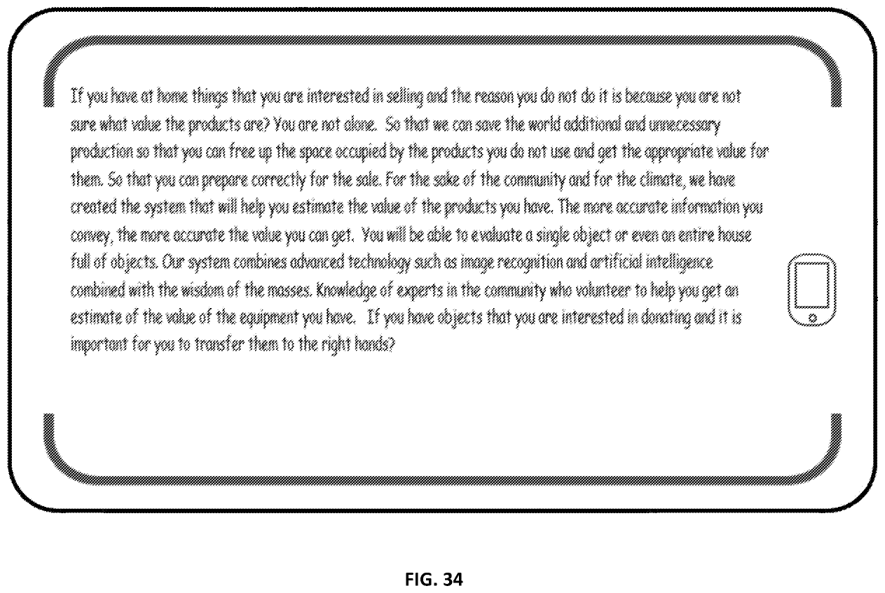

In step 1240 the user enters a requested price for the offered product. The user may ask for the system's assistance in determining the requested price. The system may comprise data-driven features (e.g. deep learning or human experts, see also FIGS. 33 and 34) to help the user to categorize goods and to evaluate the price regarding demand, median price, etc., as a decision support tool.

At each step, the user may refer back to each community's information by referring to her favorite communities 315.

System 100 operates in two general modes:
Trade mode, which provides a platform for social trading, comprising the use or reuse of products while contributing to social causes.
Volunteering mode, which predominantly uses the time, location and goodwill of volunteers to perform social activities.

### Trade Mode

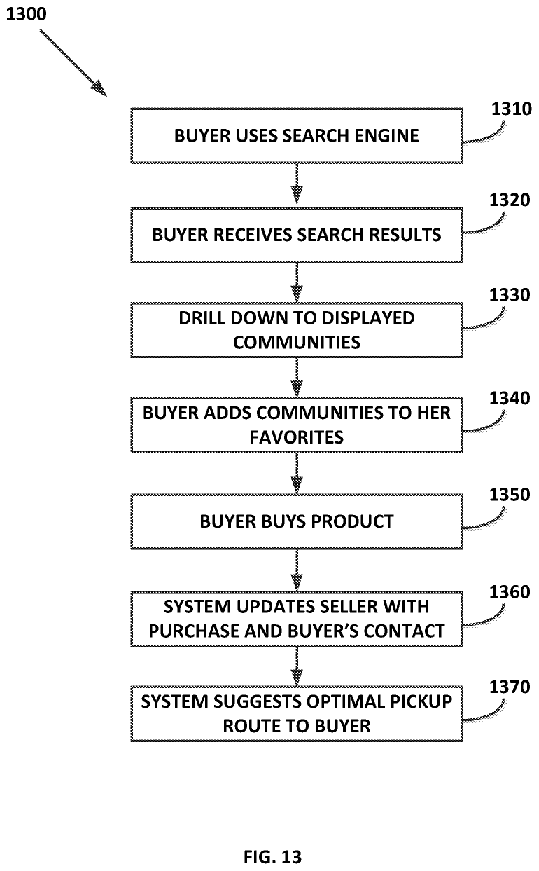

FIG. 13 is a flowchart 1300 showing a purchase operation by a buyer, who may be a registered or non-registered user of the system.

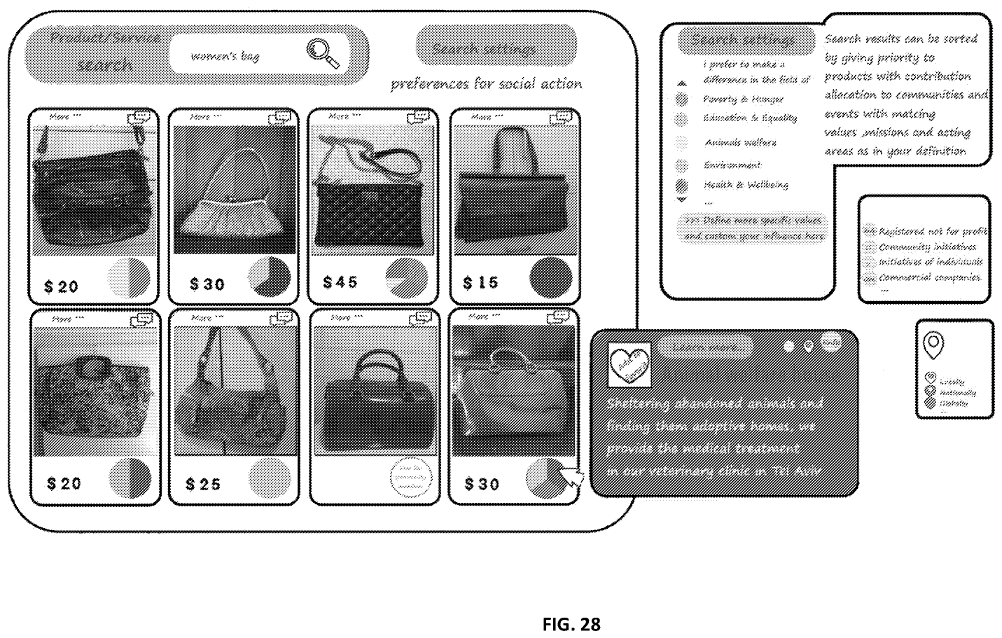

In step 1310 the buyer uses the system's search engine 600 to define the searched product. Search engine 600 allows the buyer to add social values and location information to the search terms, ad-hoc or by predefining search settings (See also FIGS. 2 and 28). The search engine communicates the search parameters to the system software 700, which searches the system databases 500 for available matching products. The search results are further filtered by sellers having similar values to those of the buyer and the communities they have defined as supporting their values. The search results may further be filtered by location information, to find products having a pick-up location close to the buyer, thus reducing delivery costs and their global impact. In step 1320 the buyer receives the search results (See also FIG. 32), including images and textual information regarding the displayed product, price, proceeds allocation to communities by the seller, pickup location, etc. The search engine may present the user with a map showing the products' locations. Each displayed product is accompanied by the system's novel e-commerce payment tool 1400, as will be explained in detail in conjunction with FIG. 14.

In step 1330, the buyer may drill down to any of the communities displayed on the payment tool 1400, for additional information.

In step 1340, if the buyer is a registered system user, she may select one or more of the seller's displayed communities to add to her favorite communities 315.

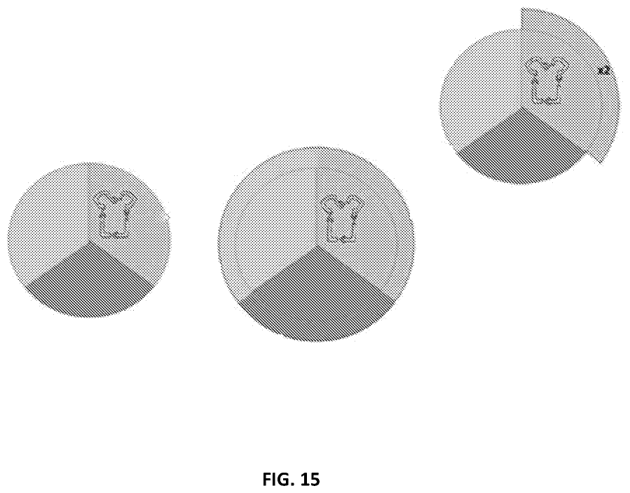

In step 1350 the buyer performs the purchase operation using the payment tool 1400, as will be explained in detail in conjunction with FIG. 15. The buyer receives the seller's contact information from system 100.

In step 1360 system 100 updates the seller with the transaction and the buyer's contact information.

In step 1370 system 100 may suggest to the buyer an optimal pickup route for the product, as will be explained in detail in conjunction with FIG. 17.

FIG. 14 is a representation of the novel payment method and funds allocation graphic tool 1400 according to the present invention. Graphic tool 1400 (shown for example in the form of a pie chart) may be added as a plug-in to any online sales page (e.g., commercial user's online store), in place of or in addition to or on top of currently available payment tools (e.g., PayPal, Credit Card, Stripe, etc.) and represents the seller's definition, in the framework of system 100, of how to allocate the proceeds of this specific sale.

Tool 1400 is a plug-in to the online sales page and is connected with system software 700. Each colored (or otherwise patterned) area of tool 1400 represents a percentage of the proceeds allocated by the seller to a different entity. The entities are preferably welfare communities, but the seller may allocate a portion to herself. System 100 may allocate a predefined percentage of the proceeds as its own profit. A feature of tool 1400 is that hovering with the marker over any of the areas provides floating summary information about the relevant community. Additionally, the area may serve as a link to the community's web portal for additional information.

The buyer selects tool 1400 for payment, using a provided selection tool such as, for example, a selection button near (1401) or inside (1402) the tool graphics.

According to embodiments of the present invention, the e-commerce payment tool 1400 may be graphically manipulated by the buyer, to augment the sum allocated to a certain community or to augment the funds allocated to each community in proportion to the original seller's definition, as shown in FIG. 15. The system also supports super donors to match, double or multiply the amount raised by the public while trading to support a community venture or event.

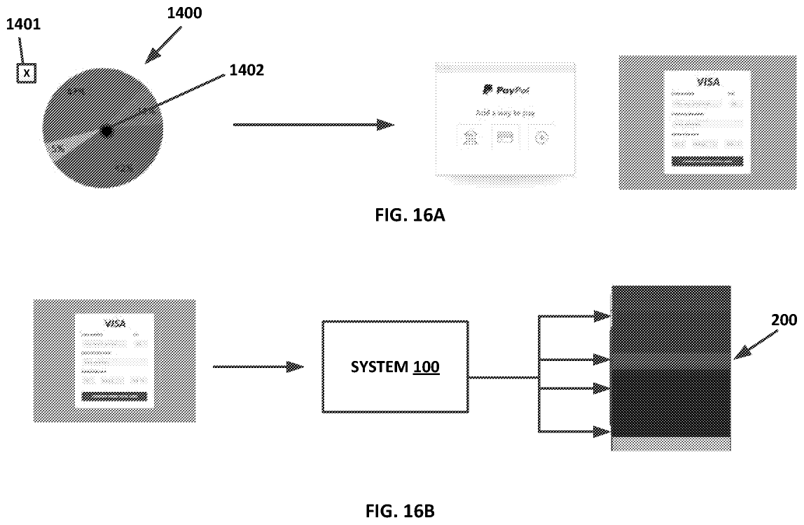

FIG. 16A is a schematic representation of the payment process according to the present invention. When a buyer selects e-commerce payment tool 1400 to perform a purchase, one or more payment options are displayed (e.g., PayPal, Visa, Stripe, Woo etc.) as known in the art. The commercial entities (banks, credit companies, etc.) behind those options are connected with system 100, to enable the use of tool 1400.

FIG. 16B is a schematic representation of the proceeds allocation process according to the present invention. Upon selection of one of the payment options (e.g., Visa) and completion of the data required by the selected payment option (e.g., name, address, CC number, and expiration date), the funds are withdrawn from the buyer's account, and transferred to the system's account, along with the allocation details. System 100 transfers the funds accordingly to the different communities. Transfer may be immediate, or the system may aggregate funds for certain communities and transfer them on pre-arranged dates or when a pre-defined sum has been aggregated.

FIG. 17 is a flowchart 1700 representing an optimal pickup route suggestion by the system, to provide a buyer with a product she had bought and paid for.

In step 1710 the system notes the seller's suggested pickup location and times, e.g., her home or work address.

In step 1720 the system software scans the buyer's contacts in the system to find a contact who is present at matching times near the seller's pickup location.

In step 1730 the system may suggest to the buyer to use the services of such contact in order to optimize the pickup route (See also FIG. 37).

### Volunteering Mode

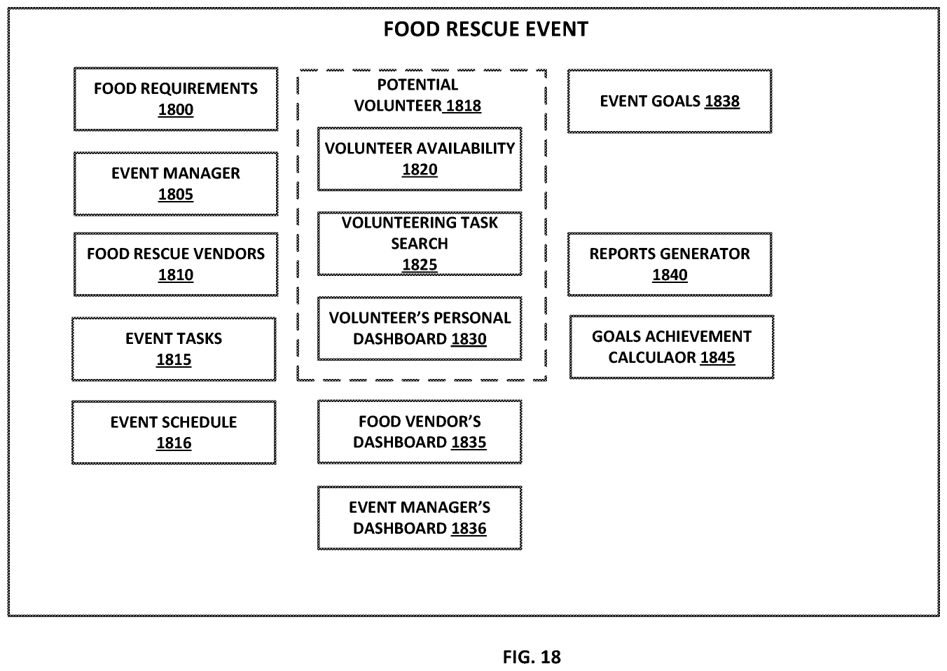

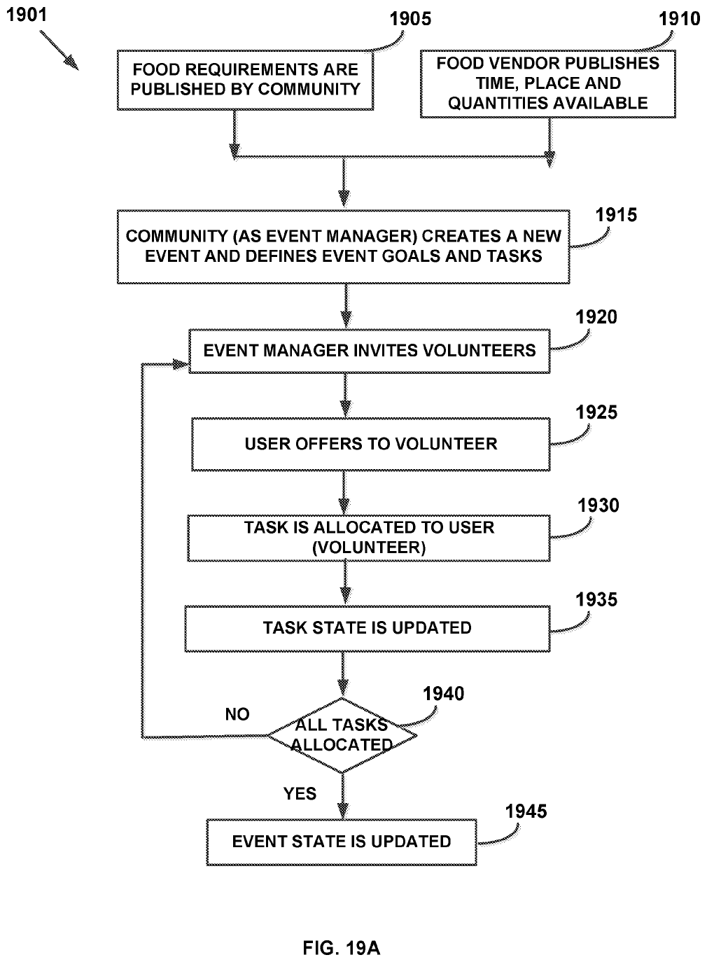

FIG. 18 is a block diagram showing the various entities involved in the system's volunteering mode and their roles, by using the example of food rescue activity.

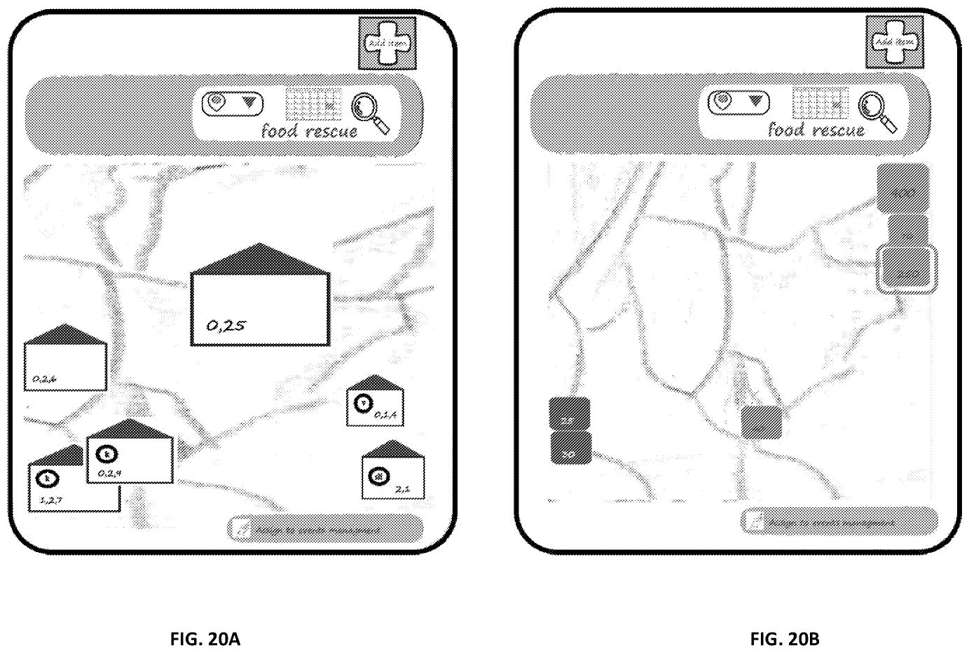

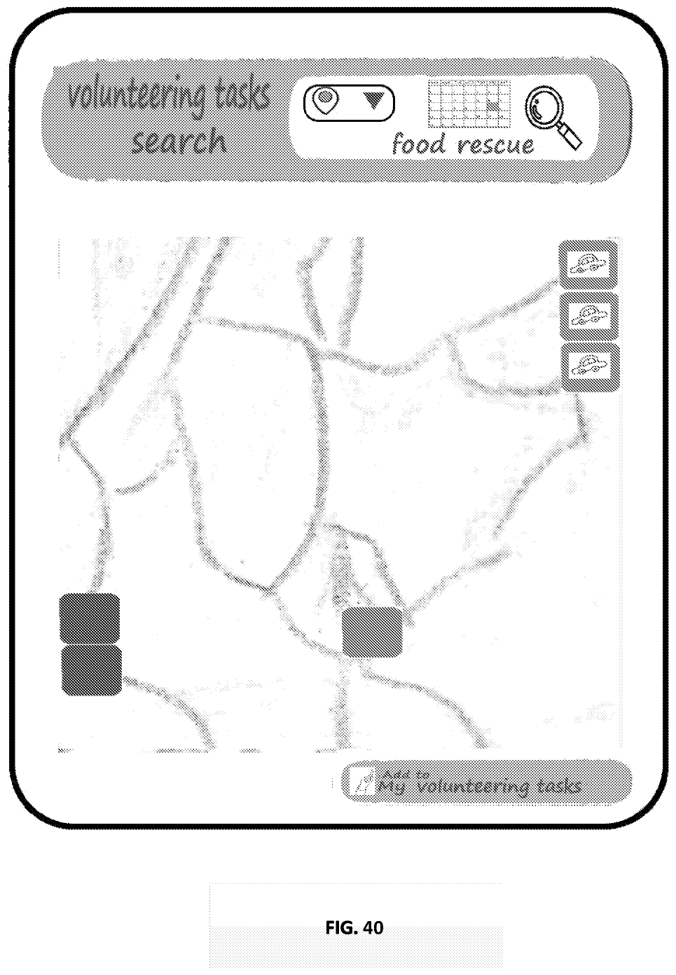

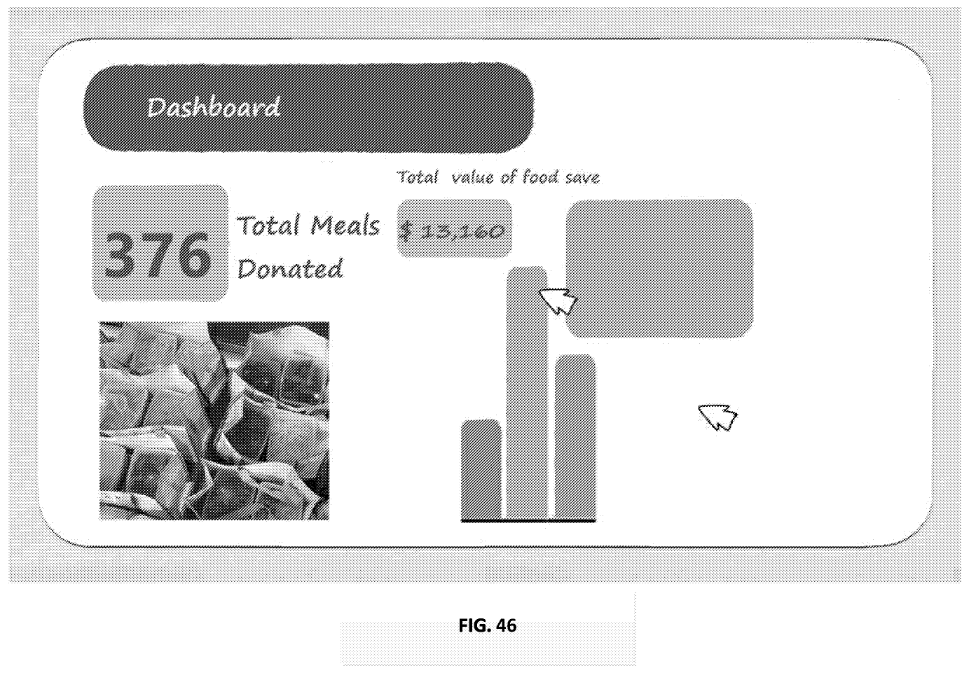

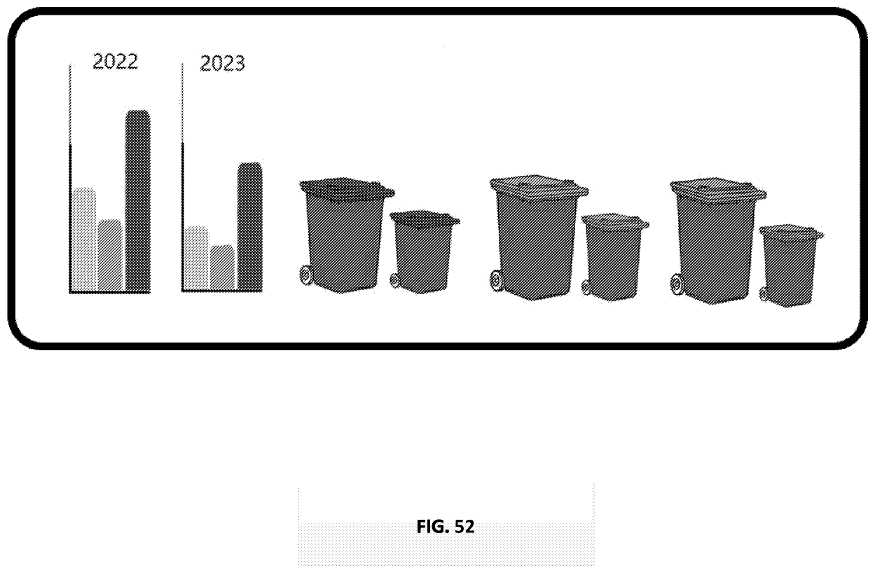

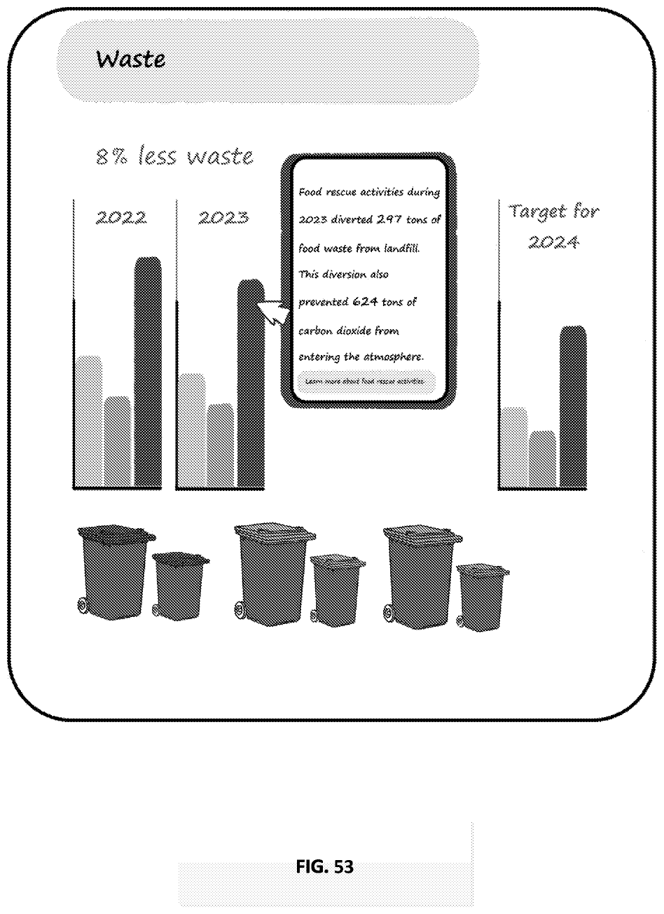

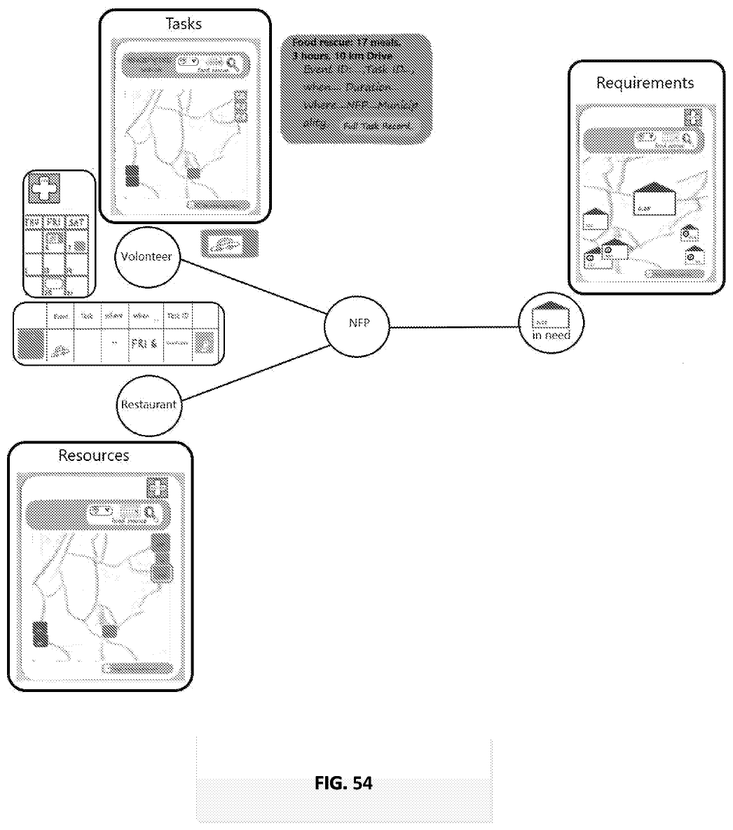

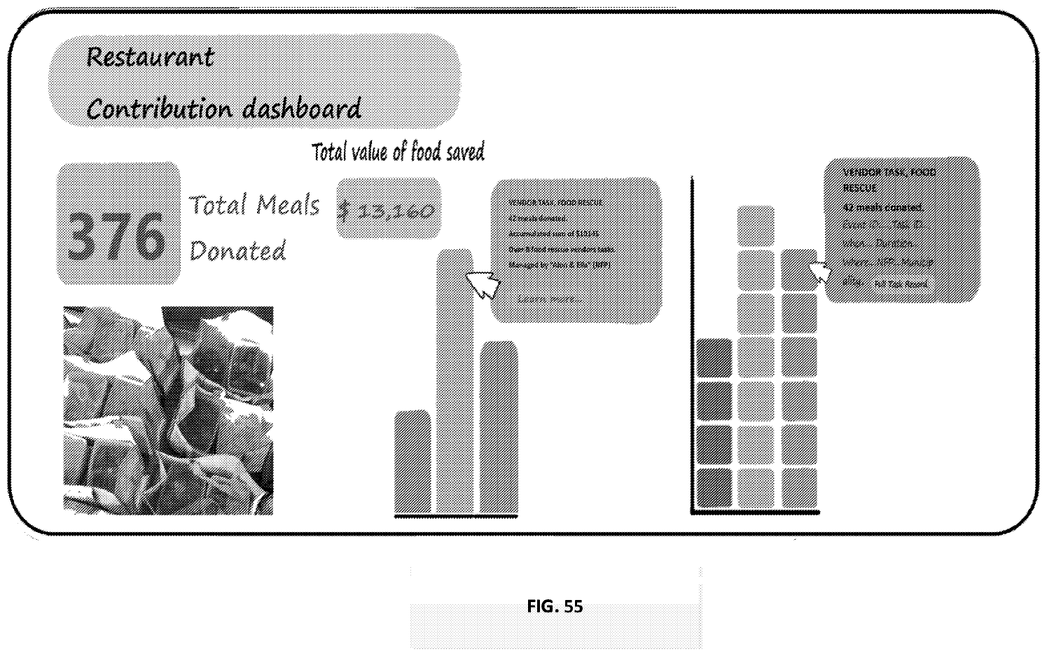

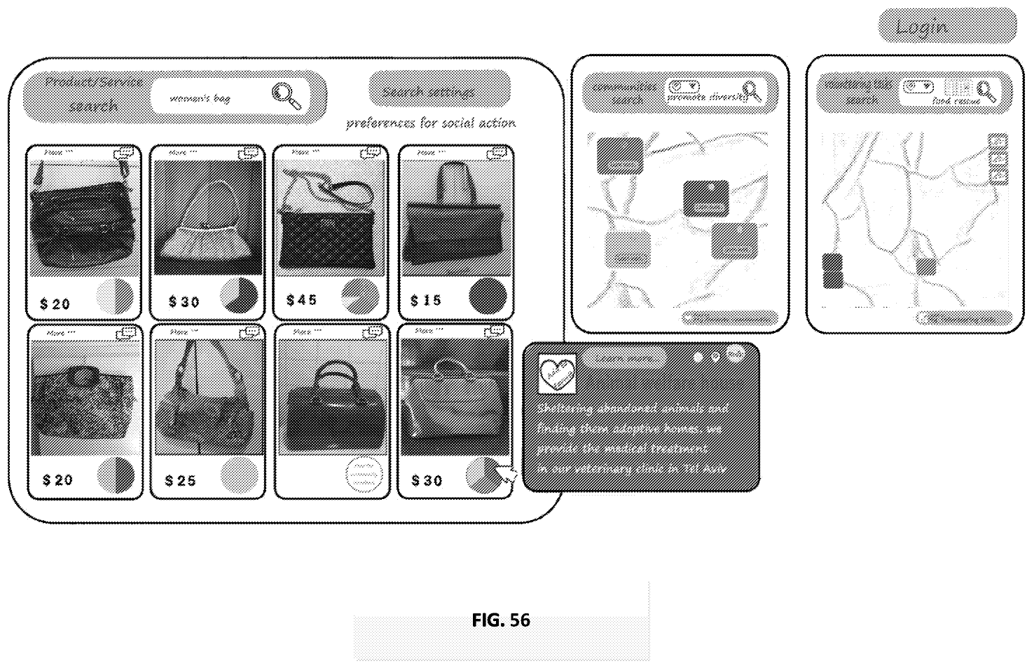

Food requirements 1800 are often published by authorized communities or municipalities, based on welfare data. The food requirements (Demand) may be presented graphically, showing locations and quantities of demand, as shown schematically in FIG. 20A. Event manager 1805 is the community, municipality, or personal entity who took upon itself the management of the event. Food rescue vendors (Supply) 1810 may be restaurant owners or managers of events involving food. The event manager creates an event by combining supply and demand. The events may be presented graphically, showing locations and quantities offered, as shown schematically in FIG. 20B and FIG. 54. The event manager 1805 may be presented with an event template 1816 to help manage the various steps involved. Alternatively or additionally, event tasks 1815 may be created by the event manager 1805 who divides the event into separate action-item tasks to be performed by volunteers. A potential volunteer's 1818 availability is preferably presented by her private calendar (FIGS. 22A and 38), showing free times she is willing to dedicate to volunteering activities, and by her proclaimed presence at certain places (FIG. 22B). Volunteering task search 1825 may be initiated by the potential volunteer 1818 (See also FIG. 40) based on requests received from various events managers or a self-initiated selection of tasks requiring volunteers that coincide with the above-mentioned times and places, as well as the volunteer's social values and the event type. Reports generator 1840 uses goals achievement calculator 1845 to create various summaries of the social, economic, and environmental contributions for each event manager (e.g., community or municipality; see also FIGS. 52 and 53), each volunteer, and for the food vendor (See also FIGS. 46 and 55) and displays these achievements on the respective dashboards (1830, 1835, 1836). The contributions are calculated by the goals-achievement calculator 1845 with respect to the event's goals 1838 as proclaimed by the events manager.

FIG. 57 shows a summary dashboard recognition of the food rescue event. This comes to demonstrate how the system endorsement can effectively grow activity and close the loop between economic profit, social contribution, and eco-friendly practices, and encourages the mutual effect while it grows exposure of contributing act, while integrating the contribution dashboard to spot-on shout out the well-deserved activity to gain more customers or to build a healthy competition by rewards

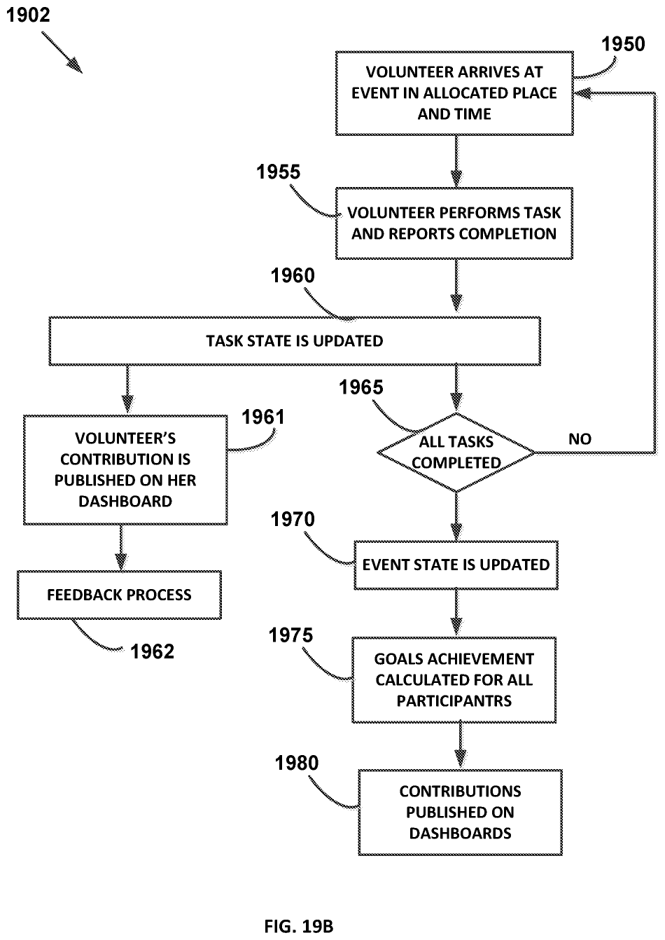

FIG. 19A is a flowchart 1901 showing an exemplary food rescue process preparation.

In step 1905 food requirements are published in the system by authorized communities or municipalities, based on welfare data. The publishing may be directed at know food suppliers and/or at the public.

In step 1910 a food vendor, such as a restaurant owner or a manager of events involving food publishes food availability, preferably including time, place, and quantities.

Steps 1905 and 1910 may be independent of each other, or the food vendor may respond to the published requirements.

In step 1915 a new event record is created in the system's events database 510 by the event manager, namely the publishing entity or someone appointed by it. The new event is divided into tasks, e.g., according to times, locations or quantities.

In step 1920 the event manager publishes the tasks, thus inviting volunteers to participate in the event. The publishing may be directed at known system users whose predefined calendars, locations and social preferences, skills, or expertise match with the required task. The quick commit reaction is a one-click operation (See FIGS. 22A and 22B). in addition, the publishing will be directed at the public in general volunteering tasks map. and picked up by suitable volunteers. In step 1925 a user offers to volunteer for one of the tasks and in step 1930 the task is allocated to the user and its state is updated (step 1935). All the relevant databases are updated with the new allocation.

In step 1845, when all tasks have been allocated, the event state is updated in the events database 510, e.g., “ready”.

FIG. 19B is a flowchart 1902 showing an exemplary food rescue process operation.

In step 1950 a volunteer arrives at the event in the allocated place and time.

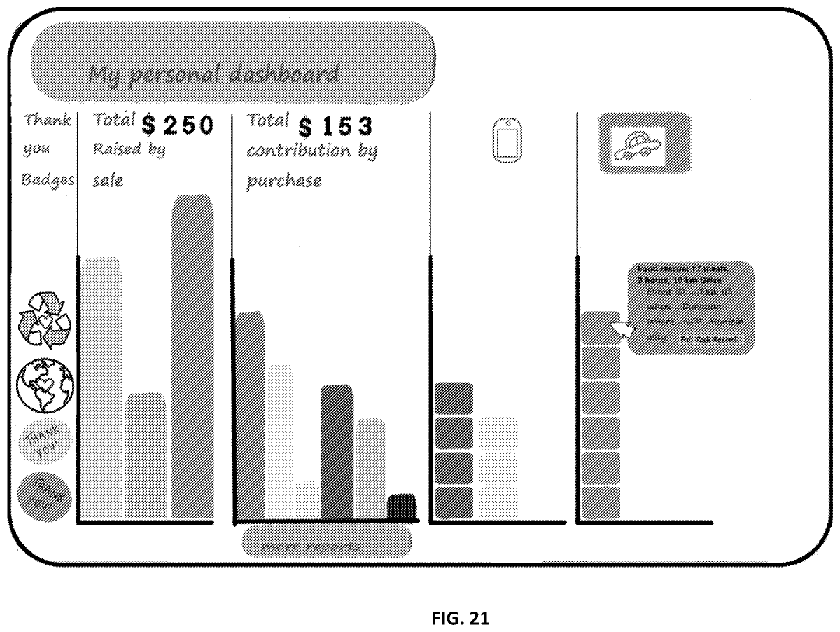

In step 1955 the user reports to the system the completion of her task and the system updates the task's state in the event's tasks management (step 1960) and this step trigger the records update in the database and presents the task on the user's dashboard (step 1961). See also FIGS. 21 and 27.

The volunteer will get the thank you notification which is a graphic representation of the records. Through the dashboard you can see the trace of all activities and their outcomes in different levels. You can learn more about each one of the entities. FIG. 21 shows schematically part of a user's dashboard detailing her various contributions and the tasks she had performed.

The volunteer may be encouraged to rate the event experience (1962) and share feedbacks. The various dashboards get updated (step 1980) as per the task definition, responsibility, entity, relevant measurable data standards etc.

For example (FIG. 57), in a food rescue event that is managed by a non-profit organization, the infographic visual reports on the varies dashboards represent the event and tasks records as they were update in the ADR Database. Once a state of a task or event has been updated (steps 1960, 1970) the event and tasks information are being generated. Each updated dashboard is a live summary of the recognition report. The dashboard of the restaurants best demonstrates how the food rescue activity contribution recognition system effectively translates to commercial success, as with the add-on widgets. The dashboard incorporated in the restaurant's digital assets, such as the digital restaurant landing page, acts as a decisive factor in the decision when potential customers checking in which restaurants to dine. The positive radial effect comes also where other restaurants and food vendors are exposed to the activity. The dashboards promote more food vendors to join the activity and make a difference with the community support, requiring minimum effort. System registration will guide the food vendor as to how easy it is to generate food rescue events. It eases the process; as all you need is to add a record of the food-saving to the resource's maps (FIG. 20B). This is a big win, affecting activity growth. As more food vendors get involved, the system tends to be able to work on a more local base. Offering local tasks may serve better the local community and is a priority as it saves time and eco-friendly reduced deliveries, it helps to build strong local communities. The same radial effect of dashboard exposure acts to grow activity as it acts in different ways: The thank you, the appreciation expression, is an essential part of the volunteering loop.

The activity “thank you” transaction is a collectable full of meaning credit point. Those are accumulated on your contribution dashboard. It is a visually quantifiable representation of activity records.

The contribution on the dashboard represents the activity results in two different stages: The first, referred to as the “activity contributions”, shows the direct achievements and the basic activity records, related to the effort the volunteer or entity devoted to the activity.

The second stage provides a wider view on the activity derivatives, the secondary influence, there is an outcomes chain, achievements of the related goals. This requires more complex analyzing and calculations by the performance calculator as shown in FIG. 57

The dashboard sums up local municipality involved in supporting the food waste rescue activities. The municipality may receive a report that sums up all the records related to food rescue activities during 2023 within the municipality area, such as:
16,335 tasks
49000 deliveries
1,020 families enjoyed stability, quality, and diversity of food.
4080 volunteers
34 non-profit organizations
180 Food vendors

The secondary influence presented, calculated (1980) from all the records may be: Diverted 297 tons of food waste from landfill. This diversion also prevented 624 tons of carbon dioxide from entering the atmosphere.

The success of one municipality to represent the achievements builds a healthy competitive process supporting surrounding municipalities, to support their local businesses, communities, and organizations to take part in similar activities.

All entities and individuals who took part in the activities will get their “backpropagation thank you” with the secondary achievement dashboard update.

When the event has been completed (step 1965), the event state is updated, e.g., “done”. Each update of a task or an event state may activate (step 1975) the performance calculator 553 to calculate each participant's contribution according to the event's goals 551, and the appropriate standard 552. In step 1980 the reports generator 554 uses the events data and the performance calculations to update the contribution of each event participant, preferably in a graphic gamification manner on the relevant dashboards.

The volunteer is asked to rate the event experience (1962) and share feedbacks, optionally to raise issues and suggestions. This aims at supporting continuous improvement in all aspects. The data may be used to score the current process and improve the recommendation system. As it aims to gather data from many sources and activity points, it may lead to adjusting the process, or even to drilling down to calibrate a part, such as to offer more appropriate scheduler templates, i.e., to improve the load balance. The data is valuable and may examine KPIs in respect to the activity, local regulation, and the different scoring of the event management and the organization. It may raise requests to the academic communities or to the public to find best practices. Any personal information or red flagged issue requiring intervention will be handed over to an authorized person to act on.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A social volunteering trade, payment and distributed-storage computerized deep network system, comprising the following entities:
social communities registered to the system;
system users using the system for selling or buying products, wherein at least part of the proceeds are donated to one or more of said communities;
at least one database comprising records pertaining to said social communities, said users and said products and to volunteering events being planned or executed;
social payment means configured to provide a buyer with donation options;
system software configured to manage and control said social trade and to match social values of said users and said communities;
a system website comprising data related to said communities, said users and their social values, said website additionally comprising connection to a search engine configured to enable said users to seek said products according to said social values;
a system network configured to communicate between said entities;
a reports module configured to calculate each community and each user's contribution to predefined goals and publish said calculation results; and
feedback means configured to back-propagate said events' outcomes,
wherein said system website comprises community entries and user entries, wherein each one of said community entries comprises:
information regarding the community's social values and activities; and
a community store listing all the products currently being offered by users for sale, wherein at least part of the sales proceeds were donated to the community; and
a link to the community's website, and
wherein said system users comprise at least one of individual users and commercial users.

2.-4. (canceled)

5. The system of claim 1, wherein at least one of said community entries comprises a wish list of products currently in urgent demand for the community's activities.

6. The system of claim 1, wherein at least one of said community entries comprises a virtual community storage comprising all the products currently being donated free of charge by said system users or by other community members to said community.

7. The system of claim 1, wherein each one of said individual user entries comprises:
information regarding the user's social values;
user's favorite communities;
personal user information;
one or more default pickup locations for products offered by the user;
default proceedings allocation; and
a user store comprising images and descriptions of products currently offered by the user, wherein each product image is accompanied by a price and a graphical representation of the proceeds allocation.

8. The system of claim 7, wherein said user entries additionally comprise a user dashboard configured to display said user's social activities in the system and their calculated contribution to one or more predefined goals.

9. The system of claim 7, wherein said user entries additionally comprise links to said user's contacts in the system.

10. The system of claim 1, wherein each one of said commercial user entries comprises:
information regarding the commercial user's social values committed to by said commercial user;
commercial user's favorite communities;
default proceeds allocation; and
link to said commercial user's online store.

11. The system of claim 10, wherein said commercial user entries additionally comprise a user dashboard configured to display said user's social activities in the system and their calculated contribution to one or more predefined goals.

12. The system of claim 1, wherein said at least one database pertaining to volunteering events comprises, for each event, an event scheduler configured to define the event's schedule, based on a learning process conducted on said feedback.

13. The system of claim 1, wherein said social payment means are designed to communicate between electronic commerce payment means and said system software, to enable distribution of a payment done by a buyer using said electronic payment means, for a product offered by a seller, according to a predefined seller allocation.

14. The system of claim 13, wherein said predefined seller allocation may be modified by at least one of said seller and said buyer.

15. The system of claim 13, wherein said social payment means represent graphically said allocation.

16. The system of claim 1, wherein said search engine is configured to search said system database for products, said search filtered by at least one of product category, searcher's social values and searcher's location information.

17. The system of claim 1, further comprising product delivery route optimization means.

18.-24. (canceled)

25. A method of offering a product for sale by a user of a social volunteering trade, payment and distributed-storage computerized deep network system, comprising the steps of:
entering said product's description and requested price into a predefined online store of said user in the system, said description comprising at least one of an image and text;
displaying by the system said user's predefined default pickup address and proceeds allocation; and
optionally modifying at least one of said pickup address and said proceeds allocation.

26. The method of claim 25, further comprising the step of requesting and receiving from the system expert help in determining said product's requested price, wherein said expert help is provided automatically by the system, based on previous transactions.

27.-28. (canceled)

29. A method of performing a product search using an online search engine provided by a social volunteering trade, payment and distributed-storage computerized deep network system, comprising the steps of:
receiving from a user search terms, wherein said search terms comprise said user's social values;
searching said systems' databases for matching products;
filtering said matched products according to sellers having social values similar to said user's social values; and
presenting said matched products to said user.

30. The method of claim 29, wherein said search terms further comprise said user's location; and wherein said filtering further comprises filtering said matched products according to sellers' locations.

31. The method of claim 30, further comprising filtering said matched products according to locations of said user or said sellers' contacts in the system, to provide a recommended pick-up route.

32. The method of claim 29, wherein said presenting comprises:
presenting said sellers' favorite communities and intended proceeds allocation between them in the system; and
enabling said user to drill down to said communities' profiles in the system.

33.-40. (canceled)
